(19) United States
(12) Patent Application Publication
(10) Pub. No.: US 2024/0038517 A1
(43) Pub. Date: Feb. 1, 2024

(54) DEVICES AND PROCESSES FOR MASS SPECTROMETRY UTILIZING VIBRATING SHARP-EDGE SPRAY IONIZATION

(71) Applicant: West Virginia University Board of Governors on Behalf of West Virginia University, Morgantown, WV (US)

(72) Inventors: Lisa HOLLAND, Morgantown, WV (US); Stephen J. VALENTINE, Morgantown, WV (US); Peng LI, Morgantown, WV (US)

(21) Appl. No.: 18/228,599

(22) Filed: Jul. 31, 2023

Related U.S. Application Data
(60) Provisional application No. 63/393,816, filed on Jul. 29, 2022.

(51) Int. Cl. H01J 49/04; G01N 27/447

(52) U.S. Cl. CPC H01J 49/045; G01N 27/44791

(57) ABSTRACT

A device may include a separation capillary having an injection end and a distal end, the injection end configured to receive analyte liquid and the distal end configured to expel the analyte liquid. A device may include a sheath capillary covering the distal end of the separation capillary, the sheath capillary having a diameter that is greater than an outer diameter of the separation capillary at the distal end, the sheath capillary having a first end and a second end, the distal end of the separation capillary positioned between the first end and the second end of the sheath capillary, the sheath capillary carrying a fluid between the second end and the first end. A device may include an acoustic probe configured to vibrate positioned in contact with the at least one of the distal end of the separation capillary or the first end of the sheath capillary.

### CROSS-REFERENCE TO RELATED APPLICATIONS

This application claims priority to U.S. Provisional Application No. 63/393,816, filed Jul. 29, 2022, entitled “Devices and Processes for Mass Spectrometry Utilizing Vibrating Sharp-edge Spray Ionization,” incorporated by reference herein in its entirety.

### STATEMENT REGARDING FEDERALLY SPONSORED RESEARCH OR DEVELOPMENT

This invention was made with government support P41 GM128577 awarded by the National Institutes of Health; and CHE2004021 awarded by the National Science Foundation. The government has certain rights in the invention.

### TECHNICAL FIELD

This disclosure relates to mass spectrometry methodology, and in particular to capillary electrophoresis and interfacing techniques between capillary electrophoresis and mass spectrometry.

### DESCRIPTION OF THE RELATED TECHNOLOGY

Mass spectrometry is one of the most information-rich analytical techniques for characterizing a broad range of samples. The past decade witnessed explosive growth in development of direct analysis and field portable mass spectrometers with the goal of bringing the analytical capability of mass spectrometry to various field applications including environmental monitoring, pharmaceutical analysis, point of care diagnosis, detection of chemical and/or biological warfare agents, forensic investigation, and discovery and research. A key component for portable mass spectrometers is an ionization source that can directly ionize the sample with minimum sample preparation and/or pretreatment. To date, numerous ambient ionization methods that allow direct sample ionization under atmospheric conditions have been reported. However, most of the existing ambient ionization methods, including desorption electrospray ionization (DESI), easy ambient sonic spray ionization (EASI), plasma-assisted desorption ionization (PADI), and direct analysis in real time (DART) require dedicated and specialized instrumentation or auxiliary gas and solvents, making them less favorable options for many field-portable mass spectrometry applications. Furthermore, complex sample preparation and pretreatment is often required. Currently, the most compelling ionization sources for portable mass spectrometers is paper spray ionization (PSI) or solid substrate-based electrospray ionization (ESI) due to their simplicity, minimal sample preparation requirements, and wide range of suitable target molecules. These techniques have been utilized in many applications including biofluid analysis, food sample analysis, and chemical reaction monitoring.

### SUMMARY

In some aspects, the techniques described herein relate to an apparatus, including: a separation capillary having an injection end and a distal end, the injection end configured to receive analyte liquid and the distal end configured to expel the analyte liquid; a sheath capillary covering the distal end of the separation capillary, the sheath capillary having a diameter that is greater than an outer diameter of the separation capillary at the distal end, the sheath capillary having a first end and a second end, the distal end of the separation capillary positioned between the first end and the second end of the sheath capillary, the sheath capillary carrying a fluid between the second end and the first end; an acoustic probe configured to vibrate positioned in contact with the at least one of the distal end of the separation capillary or the first end of the sheath capillary; and a ground terminal positioned at the first end of the sheath capillary.

In some aspects, the techniques described herein relate to an apparatus, wherein a flow rate of the fluid in the sheath capillary is less than one microliter per minute.

In some aspects, the techniques described herein relate to an apparatus, wherein a longitudinal axis of the acoustic probe is positioned between 80 degrees to 125 degrees in relation to a longitudinal axis of at least one of the separation capillary or the first end of the sheath capillary.

In some aspects, the techniques described herein relate to an apparatus, wherein the separation capillary has a length, measured between the injection end and the distal end, between 5 cm and 2 m.

In some aspects, the techniques described herein relate to an apparatus, wherein the separation capillary has a total volume of no more than 8 micro-liters.

In some aspects, the techniques described herein relate to an apparatus, wherein an inner diameter of the separation capillary is between 15 micrometers and 35 micrometers.

In some aspects, the techniques described herein relate to an apparatus, wherein a distance between the distal end of the separation capillary and the ground terminal is less than 2 millimeters.

In some aspects, the techniques described herein relate to an apparatus, wherein a voltage difference is maintained between the injection end of the separation capillary and the ground terminal.

In some aspects, the techniques described herein relate to an apparatus, wherein a flow rate of the analyte liquid in the separation capillary is between 0 nano-liters and 70 nano-liters.

In some aspects, the techniques described herein relate to an apparatus, wherein at least a portion of the inner surface of the separation capillary is coated with lipids.

In some aspects, the techniques described herein relate to an apparatus, wherein electroosmotic flow within the separation capillary is suppressed.

In some aspects, the techniques described herein relate to an apparatus, wherein the analyte liquid includes small or large molecules that are positively charged, negatively charged, or neutral charged.

In some aspects, the techniques described herein relate to an apparatus, wherein the analyte liquid includes cationic proteins and acidic background electrolytes.

In some aspects, the techniques described herein relate to an apparatus, wherein the analyte liquid includes cationic proteins, and wherein at least a portion of the inner surface of the separation capillary has at least one of a net neutral lipid coating or a hybrid cationic lipid coating.

In some aspects, the techniques described herein relate to an apparatus, wherein the at least one of a net neutral lipid coating or a hybrid cationic lipid coating is semi-permanent.

In some aspects, the techniques described herein relate to an apparatus, wherein the at least one of a net neutral lipid coating or a hybrid cationic lipid coating is positively charged.

In some aspects, the techniques described herein relate to an apparatus, wherein the analyte liquid includes anionic or neutral proteins and an electrolyte buffer at a pH of above 7.

In some aspects, the techniques described herein relate to an apparatus, wherein the fluid in the sheath capillary is an electrolyte with neutral pH.

In some aspects, the techniques described herein relate to an apparatus, wherein the fluid in the sheath capillary includes one or more amino acid additives.

In some aspects, the techniques described herein relate to an apparatus, wherein the one or more amino acid additives include at least one of L-serine, D-serine, or amino acid additives or L- or D-configuration.

In some aspects, the techniques described herein relate to an apparatus, including: a separation capillary having an injection end and a distal end, the injection end configured to receive analyte liquid and the distal end configured to expel the analyte liquid; an acoustic probe capillary having a probe end and an inlet end, the probe end of the acoustic probe capillary configured to vibrate and positioned in contact with the distal end of the separation capillary, the acoustic probe capillary carrying a fluid from the inlet end to the probe end; and a ground terminal positioned at the distal end of the separation capillary.

In some aspects, the techniques described herein relate to an apparatus, further including: a connector having a conduit for removably receiving the separation capillary, the connector including a slot to accommodate the acoustic probe capillary, wherein the conduit and the slot are positioned such that the probe end of the acoustic probe capillary makes contact with the distal end of the separation capillary.

In some aspects, the techniques described herein relate to an apparatus, wherein the connector further includes a housing to house a ground terminal, wherein the housing and the conduit are positioned to such that the ground terminal makes contact with the distal end of the separation capillary.

In some aspects, the techniques described herein relate to an apparatus, wherein a portion of the acoustic probe capillary is coupled with a vibrating structure.

In some aspects, the techniques described herein relate to an apparatus, wherein the vibrating structure includes a piezoelectric transducer.

In some aspects, the techniques described herein relate to an apparatus, wherein a flow rate of the fluid in the acoustic probe capillary is less than one microliter per minute.

In some aspects, the techniques described herein relate to an apparatus, wherein the separation capillary has a length, measured between the injection end and the distal end, between 5 cm and 2 m.

In some aspects, the techniques described herein relate to an apparatus, wherein the separation capillary has a total volume of no more than 8 micro-liters.

In some aspects, the techniques described herein relate to an apparatus, wherein a voltage difference is maintained between the injection end of the separation capillary and the ground terminal.

In some aspects, the techniques described herein relate to an apparatus, wherein an inner diameter of the separation capillary is between 15 micrometers to 35 micrometers.

In some aspects, the techniques described herein relate to an apparatus, wherein a distance between the distal end of the separation capillary and the ground terminal is less than 2 millimeters.

In some aspects, the techniques described herein relate to an apparatus, wherein a flow rate of the analyte liquid in the separation capillary is between 0 nano-liters and 70 nano-liters.

In some aspects, the techniques described herein relate to an apparatus, wherein at least a portion of the inner surface of the separation capillary is coated with lipids.

In some aspects, the techniques described herein relate to an apparatus, wherein electroosmotic flow within the separation capillary is suppressed.

In some aspects, the techniques described herein relate to an apparatus, wherein the analyte liquid includes small or large molecules that are positively charged, negatively charged, or neutral charged.

In some aspects, the techniques described herein relate to an apparatus, wherein the analyte liquid includes cationic proteins and acidic background electrolytes.

In some aspects, the techniques described herein relate to an apparatus, wherein the analyte liquid includes cationic proteins, and wherein at least a portion of the inner surface of the separation capillary has at least one of a net neutral lipid coating or a hybrid cationic lipid coating.

In some aspects, the techniques described herein relate to an apparatus, wherein the at least one of a net neutral lipid coating or a hybrid cationic lipid coating is semi-permanent.

In some aspects, the techniques described herein relate to an apparatus, wherein the at least one of a net neutral lipid coating or a hybrid cationic lipid coating is positively charged.

In some aspects, the techniques described herein relate to an apparatus, wherein the analyte liquid includes anionic or neutral proteins and an electrolyte buffer at a pH of above 7.

In some aspects, the techniques described herein relate to an apparatus, wherein the fluid in the acoustic probe capillary is an electrolyte with neutral pH.

In some aspects, the techniques described herein relate to an apparatus, wherein the fluid in the acoustic probe capillary includes one or more amino acid additives.

In some aspects, the techniques described herein relate to an apparatus, wherein the one or more amino acid additives include at least one of L-serine, D-serine, or amino acid additives or L- or D-configuration.

In some aspects, the techniques described herein relate to a connector, including: a connector body having a first end and a second end; a conduit extending between the first end and the second end of the connector body, the conduit configured to removably receive a separation capillary, wherein a portion of the conduit at the first end of the connector body accommodates a distal end of the separation capillary; and an acoustic probe slot positioned at the first end of the connector body, the acoustic probe slot extends between an outside surface of the connector body and the inner surface of the conduit, the acoustic probe slot configured to removably receive an acoustic probe having a sheath capillary.

In some aspects, the techniques described herein relate to a connector, further including: a ground terminal slot positioned at the first end of the connector body, the ground terminal slot extends between an outside surface of the connector body and an inner surface of the conduit, ground terminal slot configured to removably receive a ground terminal.

In some aspects, the techniques described herein relate to a connector, further including: A dead stop positioned in the conduit at the first end of the connector body, the dead stop configured to have a diameter that is less than a diameter of the separation capillary such that the separation capillary is prevented from being pushed out of the conduit at the first end.

In some aspects, the techniques described herein relate to a connector, wherein the connector body is formed of at least one of metal or thermoplastic.

In some aspects, the techniques described herein relate to a connector, wherein the connector body includes a dead stop formed on an inner surface of the conduit, wherein the dead stop has a diameter that is less than the diameter of the separation capillary.

In some aspects, the techniques described herein relate to a connector, wherein the connector body includes: a nut portion and a port portion, wherein the nut portion screws into the port portion, wherein a portion of the conduit is formed in the nut portion and a second portion of the conduit is formed in the port portion, and a dead stop formed on the inner surface of the second portion of the conduit in the port portion, wherein the dead stop has a diameter that is less than the diameter of the separation capillary.

In some aspects, the techniques described herein relate to a connector, further including; a ground terminal slot positioned at the first end of the connector body, the ground terminal slot extends between an outside surface of the connector body and an inner surface of the conduit, ground terminal slot configured to removably receive a ground terminal, wherein the ground terminal slot is formed in the port portion.

In some aspects, the techniques described herein relate to a connector, wherein the acoustic probe slot is formed in the port portion.

### BRIEF DESCRIPTION OF THE DRAWINGS

FIG. 1 shows a first example analysis apparatus 100 including capillary electrophoresis and vibrating sharp-edge spray ionization (VSSI).

FIG. 2A-2D: FIG. 2A shows an image of an angular VSSI spray direction as visualized in the presence of a scattered green light. The COMSOL simulation shown in FIG. 2B demonstrates the angular direction of the velocity field and the VSSI probe. In FIG. 2C, droplets collected from the VSSI into mineral oil are sized with optical microscopy and to obtain the histogram shown in FIG. 2D depicting the distribution of droplet size.

FIG. 3 shows CE-VSSI-MS separation of 1 μM beta blockers. Separation was achieved with a SO cm (total and effective length), 20 μm internal diameter (i.d.) capillary at an applied voltage of 12 kV with a current of 3.2 μA and injection voltage of 3 kV 4 s. The trace is obtained using masses of 249.1595 and 337.1118 for pindolol and acebutolol, respectively, with a mass tolerance of 50 ppm. For all separations, the sheath fluid is the same as the background electrolyte, which is 50 mM acetic acid adjusted to pH 4.7 with ammonium hydroxide, 50 mM ammonium acetate with a pH of 6.3, or 50 mM ammonium acetate adjusted to a pH of 9.1 with ammonium hydroxide. The sheath flow rates are 650 nL/min (pH 6.3) and 733 nL/min (pH 4.7 and 9.1).

FIG. 4A shows CE-UV separation of 200 μM pindolol, oxprenolol, atenolol, timolol, and acebutolol. Separation was achieved with a 40 cm (total length), 30 cm (effective length), 25 μm i. d. capillary at an applied voltage of 21.3 kV with a current of 8.8 μA and injection voltage of 10 kV for 2 s. FIG. 4B shows CE-VSSI-MS separation of 10 nM beta blockers. Separation was achieved with a 27 cm (total and effective length), 20μ i. d. capillary at an applied voltage of 16 kV with a current of 11 μA and injection voltage of 20 kV for 2 s. The trace is obtained using masses of 249.1594, 266.1746, 267.1683, 317.1639, and 337.1212 for pindolol, oxprenolol, atenolol, tinlolol, and acebutolol, respectively, with a mass tolerance of 10 ppm. The sample is injected with electrokinetic stacking achieved by diluting the sample in 1 mM ammonium acetate. All separations are performed using a background electrolyte of 50 mM ammonium acetate with a pH of 6.3. The sheath flow rate is 900 nL/min.

FIG. 5A shows a CE-VSSI-MS separation of 1 μM lysine, arginine, histidine, respectively, and 5 μM valine, leucine, asparagine, threonine, glutamine, tryptophane, glutamic acid, phenylalanine, proline, and tyrosine. The extracted ion electropherograms were created using masse, of 147.1127, 175.1188, 156.0767, 118.0864, 132.1019, 133.0607, 120.0602, 147.0762, 205.0974, 148.0602, 166.0861, 116.0708, and 182.0811 for lysine, arginine, histidine, valine, leucine, asparagine, threonine, glutamine, tryptophane, glutamic acid, phenylalanine, proline, and tyrosine, respectively, with a mass tolerance of 10 ppm. Separation was achieved with a 30 cm (total and effective length), 25 μm i. d. capillary at an applied voltage of 12 kV with a current of 8.211 A and injection voltage of 20 kV for 3 s. The sheath flow rate is 900 nL/min. FIG. 5B shows the CE-UV separation of 100 μM arginine, histidine, tryptophane, phenylalanine, and tyrosine and 250 μM asparagine and glutamine. Separation was achieved with a 40 cm (total length), 30 cm (effective length), 25 μm i. d. capillary at an applied voltage of 16 kV with a current of 8.1 μA and injection voltage of 10 kV for 4 s. Stacking was achieved using 0.004% formic acid, and all separations were achieved using 2% formic acids as background electrolyte.

FIG. 6A shows the CE-VSSI-MS separation of 1 μM non-steroidal anti-inflammatory drugs (NSAIDs). The extracted ion electropherograms are created using masses of 261.0577, 258.1123, 255.1013, and 282.1127 for suprofen, tolmetin, ketoprofen, and indoprofen, respectively, with a mass tolerance of 10 ppm. Separation is achieved with a 30 cm (total and effective length), 25 μm i. d. capillary at an applied voltage of −16 kV with a current of −11.2 to −14.9 μA and injection voltage of −20 kV for 2 s. FIG. 6B shows the CE-UV separation of 20 μM suprofen, tolmetin, ketoprofen, and indoprofen. Separation is achieved with a 40 cm (total length), 30 cm (effective length), 25 μm i. d. capillary at an applied voltage of −21.3 kV with a current of −8.0 μA and injection voltage of −100 kV for 2 s; stacking achieved using 1 mM ammonium acetate, and all separations were performed at pH 6.3, 50 mM ammonium acetate as background electrolyte. The sheath flow rate is 900 nL/min.

FIG. 7 shows a photograph of a nanoflow sheath design similar to that depicted in FIG. 1 aligned with a VSSI probe.

FIG. 8 shows representative electropherograms for CE-VSSI-MS of 1.0 μM pindolol (pin) and acebutolol (ace) and 15 μM caffeine (caff) as a neutral flow marker. Signals obtained at m/z 249.1598 (pin), 337.2123 (ace), and 195.0878 (caff). Conditions as in FIG. 3 above. Migration times at pH 4.7, 6.3, 9.1 are as follows: pin: 7.86, 6.12, 4.51 min; ace: 8.69, 6.64, 4.78 min; caff: 14.29, 9.22, 5.78 min, respectively. Volumetric flow rates are calculated by dividing the volume (154 nL) of the 49 cm, 20 μm i. d. capillary by the migration time of caffeine, which is the neutral marker. This is calculated as πr²l/t_{eof}, where r is the radius, l is the length, and t_{eof} is the migration time of the caffeine. These calculations yield flow rates of 11, 17, and 27 nL/min at pH 4.7, 6.3, and 9.1, respectively.

FIG. 9 shows Table S1 detailing CE-UV and CE-VSSI-MS figures of merit for R blockers: Stacking.

FIG. 10 shows Table S2 detailing the effect of temperature on electrokinetic-stacked injected p blockers.

FIGS. 11A-11B show separations obtained with electrokinetic injections without stacking. FIG. 11A shows the CE-UV separation of 400 μM pindolol, oxprenolol, atenolol, timolol, and acebutolol. Separation was achieved with a 40 cm (total length), 30 cm (effective length), 25 μm i. d. capillary at an applied voltage of 21.3 kV with a current of 8.8 μA, and injection voltage of 10 kV for 2 seconds. Sample is injected with no electrokinetic stacking achieved by diluting sample in 50 mM ammonium acetate. All separations are performed using a background electrolyte of 50 mM ammonium acetate with a pH of 6.5. FIG. 11B shows the CE-VSSI-MS separation of 100 nM beta blockers. Separation was achieved with a 27 cm (total and effective length), 25 μm i. d. capillary at an applied voltage of 16 kV with a current of 11 μA and Injection voltage of 20 kV for 2 sec. The trace is obtained using masses of 249.1594, 266.1746, 267.1683, 317.1639, and 337.2131, for pindolol, oxprenolol, atenolol, timolol, and acebutolol, respectively, with a mass tolerance of 10 ppm.

FIG. 12 shows Table S4 depicting peak areas obtained for p blockers with no stacking.

FIG. 13 shows Table S5 depicting linear regression for UV and MS β blocker curves.

FIG. 14 shows Table S6 depicting stacking enhancement for β blockers as calculated by calibration slope ratio.

FIG. 15 shows Table S7 depicting peak areas obtained for evaluation of linear range with amino acids.

FIG. 16 shows Table S8 depicting linear regression for CE-VSSI-MS amino acid curves.

FIG. 17 shows Table S9 depicting figures of merit for CE-VSSI-MS and CE-UV separations of amino acids.

FIG. 18 shows PeakMaster simulation of CZE separation of amino acids at conditions matching FIG. 5 (2% formic acid BGE at pH 2.0, 12 kV separation potential, 30 cm capillary, EOF mobility of 1.4×104 cm2/Vs) with amino acid properties provided by the PeakMaster database as based on previously reported values (pKa and mobility). As many amino acids do not have a chromophore and cannot be detected with UV absorbance, these simulated data allowed for prediction of the migration order for the full set of amino acids considered in this work. Although tryptophan and proline migrate a bit slower than predicted by the simulation and arginine migrates faster than predicted, the simulation otherwise shows remarkable similarity to the CE-VSSI-MS data in FIG. 5.

FIG. 19A depicts the molecular structures of ketoprofen and indoprofen. FIG. 19B demonstrates bar graph of signal intensity of indoprofen and ketoprofen at pH 2, 6.5, and 10 in 50 mM acetic acid, ammonium acetate, and ammonium hydroxide at positive (10 μM) and negative (100 μM) MS mode. Direct infusions were achieved with a 30 cm (total and effective length), 25 μm i. d. capillary at 100 kPa (15 psi).

FIG. 20 shows Table S10 depicting comparison of figures of merit for electrokinetic (EK) injected NSAIDs.

FIG. 21 shows Table S11 depicting peak areas for evaluation of NSAID linear ranges.

FIG. 22 shows Table S12 depicting linear regression for UV and MS NSAIDs curves.

FIG. 23 shows a portion of the first example analysis apparatus 100 and shows modified and unmodified separation capillary.

FIG. 24A shows a photograph of an example CE-VSSI apparatus and FIG. 24B shows a schematic depicting the components of the first analysis apparatus shown in FIG. 1.

FIGS. 25A-25F show bare-fused silica CE-VSSI-MS extracted ion chromatograms (XIC) of (FIG. 25A) 5 μM β-lactoglobulin B (FIG. 25C) 5 μM β-lactoglobulin A (FIG. 25D) 10 μM transferrin. (D inset) Direct infusion of 50 μM transferrin. Separation conditions as follows: 30 cm, 25 μm i.d. capillary with a 5 psi, 2 s injection and 12 kV applied voltage. The background electrolyte is 25 mM ammonium acetate with 20 mM methylmorpholine, pH 7.6. The sheath is aqueous 10 mM L-serine.

FIG. 26 shows results of bare-fused silica CE-VSSI-MS (FIG. 26A) XIC and accompanying spectra for (FIG. 26B) 2.5 μM cytochrome c, (FIG. 26C) 10 μM ribonuclease A, and (FIG. 26D) 10 μM α-chymotrypsinogen A. Separation achieved with a 30 cm, 25 μm i. d. capillary with a 10 kV, 3 s injection and 12 kV applied. The background electrolyte is 1 N acetic acid and sheath is water.

FIG. 27A depicts the self-assembled zwitterionic phospholipid bilayer on the capillary surface and FIG. 27B shows the cetyltrimethylammonium bromide (CTAB) in the flushing protocol results in the insertion of cetyltrimethylammonium in the bilayer to form a stable cationic coating that generates an electroosmotic flow (EOF). Note that the electrophoretic (EPH) mobility is reversed relative to the phospholipid coating in FIG. 27A.

FIG. 28A shows results of a phospholipid coated CE-VSSI-MS. FIG. 28B depicts XIC and accompanying spectra for (FIG. 28B) 2.5 μM cytochrome c, (FIG. 28C) 5 μM ribonuclease A, and (FIG. 28D) 10 μM α-chymotrypsinogen A. The background electrolyte is 25 mM ammonium acetate and sheath is 2.5 mM ammonium acetate with 10 mM L-serine. Other conditions similar to those provided in relation to FIG. 25.

FIG. 29A shows results of bare-fused silica CE-VSSI-MS, XIC and accompanying spectra for (FIG. 29B) 2.5 μM cytochrome c, (FIG. 29C) 10 μM ribonuclease A, and (FIG. 29D) 10 μM α-chymotrypsinogen A. Separation achieved with a 30 cm, 25 μm i. d. capillary with a 10 kV, 3 s injection and 12 kV applied. The background electrolyte is 1 N acetic acid and sheath is water.

FIG. 30 shows Table S1 depicting protein molecular weight and isoelectric point of various proteins.

FIG. 31A shows a microscope image of an example VSSI probe with a 54 μm outer diameter tip, FIG. 31B shows a microscope image of aqueous droplets produced by VSSI spray collected in mineral oil, and FIG. 31C shows size distribution of droplets shown in FIG. 31B.

FIG. 32 shows bare-fused silica VSSI-MS mass spectra of direct infused 10 μM β-lactoglobulin analyzed with a background electrolyte comprised of 25 mM ammonium acetate, 20 mM methylmorpholine buffered to pH 7.6. The sheath is maintained with an applied pressure of 62 kPa (9 psi) for the different sheath solutions. (A-C) Effect of ionic strength on signal suppression. (D-F) Effect of 10 mM L-serine on peak adduction. (G) Effect of acid on adduction. (H,I) Effect of acid and 10 mM L-serine on adduction. Imax is the maximum ion intensity of each spectrum averaged over 2 min. The direct infusion is achieved with an applied pressure of 69 kPa (10 psi) with a 30 cm long, 25 μm inner diameter capillary.

FIG. 33A shows a VSSI probe modified to accept sheath fluid delivery through the probe. The VSSI probe functions as the sheath capillary alleviating the need for a sheath capillary to cover the separation capillary in the manner shown in FIG. 1. To demonstrate effective mixing the spray formation of the combination of the analyte liquid and the sheath fluid, two different fluorophores, Cy-5 and fluorescein, are introduced in the separation capillary and the VSSI probe sheath capillary, respectively, and droplets are captured and imaged microscopically. FIGS. 33B and 33C show images using Cy-5 and fluorescein filters, respectively, of the deposition of the spray on an oil medium to confirm that the deposit includes both Cy-5 and fluorescein.

FIGS. 34A and 34B show top and front views of a second example analysis apparatus that incorporates the sheath capillary into the VSSI probe.

FIG. 35 shows an example VSSI probe with the sheath capillary incorporated therein.

FIG. 36 shows a schematic of an analysis system that incorporates the second example analysis apparatus discussed in relation to FIGS. 34A and 34B with commercial CE and MS apparatuses.

FIG. 37 shows side and front views of a first example connector that can be used in conjunction with a CE-VSSI-MS system.

FIG. 38 shows a cross-sectional view of a second example connector 3800 that can be used in conjunction with a CE-VSSI-MS system.

Like reference numbers and designations in the various drawings indicate like elements.

### DETAILED DESCRIPTION

The various concepts introduced above and discussed in greater detail below may be implemented in any of numerous ways, as the described concepts are not limited to any particular manner of implementation. Examples of specific implementations and applications are provided primarily for illustrative purposes.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used in the specification and the appended claims, the singular forms “a,” “an” and “the” include plural referents unless the context clearly dictates otherwise. Thus, for example, reference to “a proton beam degrader,” “a degrader foil,” or “a conduit,” includes, but is not limited to, two or more such proton beam degraders, degrader foils, or conduits, and the like.

The various concepts introduced above and discussed in greater detail below may be implemented in any of numerous ways, as the described concepts are not limited to any particular manner of implementation. Examples of specific implementations and applications are provided primarily for illustrative purposes.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

Coupling capillary electrophoresis (CE) to mass spectrometry (MS) is a powerful strategy to leverage a high separation efficiency with structural identification. Traditional CE-MS interfacing relies upon voltage to drive this process. Additionally, sheathless interfacing requires that the electrophoresis generates a sufficient volumetric flow to sustain the ionization process. Vibrating sharp-edge spray ionization (VSSI) is a new method to interface capillary electrophoresis to mass analyzers (VSSI is discussed in further detail in U.S. Pat. No. 11,600,481, which is incorporated by reference herein in its entirety). In contrast to traditional interfacing, VSSI is voltage-free, making it straightforward for CE and MS. New nanoflow sheath CE-VSSI-MS is introduced herein to reduce the reliance on the separation flow rate to facilitate the transfer of analyte to the MS. The nanoflow sheath VSSI spray ionization functions at less than 1 microliter per min, or for example from 400 to 900 nL/min. Using the nanoflow sheath discussed herein, volumetric flow rate through the separation capillary is less critical, allowing the use of a small (e.g., 15 to 35 μm or 20 to 25 μm) inner diameter separation capillary and enabling the use of higher separation voltages and faster analysis. Moreover, the use of a nanoflow sheath enables greater flexibility in the separation conditions. The nanoflow sheath can be operated using aqueous solutions in the background electrolyte and in the sheath, demonstrating the separation can be performed under normal and reversed polarity in the presence or absence of electroosmotic flow. This includes the use of a wider pH range as well. The versatility of nanoflow sheath CE-VSSI-MS is demonstrated by separating cationic, anionic, and zwitterionic molecules under a variety of separation conditions. The detection sensitivity observed with nanoflow sheath CE-VSSI-MS is comparable to that obtained with sheathless CE-VSSI-MS as well as CE-MS separations with electrospray ionization interfacing. A bare fused silica capillary can be used to separate cationic β-blockers with a near-neutral background electrolyte at concentrations ranging from 10 nM to 5 μM. Under acidic conditions, 13 amino acids are separated with normal polarity at a concentration ranging from 0.25 to 5 μM. Finally, separations of anionic compounds are demonstrated using reversed polarity under conditions of suppressed electroosmotic flow through the use of a semipermanent surface coating. With a near-neutral separation electrolyte, anionic nonsteroidal anti-inflammatory drugs are detected over a concentration range of 0.1 to 0.5 μM.

Mass spectrometry provides critical information about and bioanalytical research, especially when combined with liquid chromatography separations to reduce the sample complexity prior to mass analysis (Ref. 1-1). Although liquid chromatography is a prevalent separation method coupled to MS, capillary electrophoresis is an alternative liquid-based separation method that has been successfully interfaced to MS through electrospray ionization. Capillary electrophoresis offers the advantages of low volume sample requirements, automation, and fast runs (Ref 1-2). These features make an integrated capillary electrophoresis MS system a powerful technique for metabolomics (Refs. 1-3-1-7), proteomics (Refs. 1-8-1-9), glycomics (Ref 1-10), biomarkers (Refs. 1-11-1-14), and affinity binding (Refs. 1-15-1-16). Notable applications of capillary electrophoresis-electrospray ionization-mass spectrometry (CE-ESI-MS) include analyses at the cellular level (Refs. 1-3, 1-4, 1-7-1-9) as well as pharmaceutical determinations ranging from purity, degradation, and metabolite studies (Ref 1-17). Progress in the coupling of capillary electrophoresis and MS continues to advance applications that integrate these methods (Ref 1-18).

Electrospray ionization is interfaced directly to the mass analyzer as a sheathless flow, or it includes an additional sheath flow to assist in the electrospray process. The incorporation of a sheath flow offers greater flexibility in the design of the capillary electrophoresis separation. This is particularly important under conditions of suppressed or reversed electroosmotic flow in which there is little or no bulk fluid flow exiting the separation capillary. Although the use of a sheath flow sustains the electrospray process, it also dilutes the analyte band exiting the separation capillary. This process of analyte dilution can be minimized by reducing the volumetric flow rate of the sheath to nanoliters per minute. In a recent comparison of sheathless electrospray ionization to nanoflow sheath electrospray ionization, the addition of the sheath demonstrated a 10- to 100-fold dilution factor depending on the analyte (Ref 1-19). Different strategies are reported to achieve nanoliter/minute flow rates (Ref. 1-18). The use of a sheath flow of 400 nL/min19 or lower (Ref 1-20) was achieved by splitting the fluid flow delivered by a syringe pump operated at 4 μL/min. With a 3D printed plug-and-play design, the separation capillary and sheath capillary are positioned in a way that prevents back-flow into the separation capillary (Ref 1-20). A second design integrated in a commercial instrument (Ref 1-21) delivers a nanoflow sheath reported to be 50 nL/min22 through electrokinetic pumping of fluid.

Vibrating sharp-edge spray ionization (VSSI) is an alternative method of interfacing liquid separations to MS. VSSI achieves sample nebulization and ionization through the generation and application of acoustic waves through a sharp edge coupled to a piezoelectric transducer. The introduction of acoustic waves to the liquid surface results in a plume of droplets that desolvate to produce gas phase ions suitable for MS analysis. Different designs couple the acoustic energy and liquid through the sharp edge, including the corner of a piece of glass for direct contact-based nebulization (Ref. 1-23-1-24) or using a capillary attached to the piece of glass (Ref. 1-25-1-29) with fluid through the capillary. Unlike traditional electrospray interfacing, VSSI is voltage-free ionization and does not utilize nebulizer gas. Organic additives, which are commonly used to assist electrospray ionization interfacing, are compatible with VSSI and decrease droplet size.23 VSSI is compatible with fluid flow rates from 5 to 50 μL/min when the liquid passes through the probe in a design similar to what is observed with electrospray systems (Ref 1-23, 1-25, 1-27). Lower flow rates have been coupled to VSSI with field (Ref 1-26) or when liquid is brought into contact with the tip of the glass VSSI probe as was previously reported in a sheathless capillary electrophoresis-VSSI-mass spectrometry (CE-VSSI-MS) design (Ref 1-30). In that report, for the first time, a hollow pulled probe was used on the corner of a glass slide attached to the piezoelectric transducer and functioned with flow rates ranging from 70 to 200 nL/min.

Some sheathless CE-VSSI-MS systems demonstrate a limit of detection of 2 nM (Ref 1-30) which was comparable to limits of detection of 0.7 nM for beta blockers obtained with a sheathless CE-ESI-MS system (Ref 1-31). Sheathless CE-ESI-MS interfacing can be ideal for low detection limits because it avoids analyte dilution. For example, the introduction of a nanoflow sheath to CE-ESI-MS systems increased the limit of detection to 70 nM (Ref. 1-32). While the sheathless CE-VSSI-MS system was capable of detecting nanomolar levels of analyte (Ref. 1-30) separation conditions were limited to the use of a 50 μm inner diameter separation capillary and background electrolyte systems that maintained an electroosmotic flow sufficient to sustain the VSSI process.

These challenges are overcome using a sheath flow CE-VSSI-MS operated at sub-microliter per minute flow rates (e.g., 400-900 nL/min) regardless of the separation flow rate. The sheath flow can considerably reduce the requirements for an electroosmotic flow, and it enables the use of a smaller bore capillary. The use of a smaller inner diameter reduces the effects of siphoning and allows for the application of a higher separation voltage, which reduces the run time. This modular design makes the VSSI probe and capillary independent so that either is easily replaced. With the probe design, the interaction of the fluid and the sharp edge directs the nebulized plume in an angular fashion. The nanoflow sheath design is capable of detecting 10 nM pindolol with a separation efficiency of 50,000 plates per meter.

The functionality of the nanoflow sheath CE-VSSI-MS system is evaluated under different conditions to demonstrate the flexibility of this technique. The nanoflow sheath is operated using aqueous solutions in the background electrolyte and in the sheath, demonstrating the separation can be performed under normal and reversed polarity in the presence or absence of electroosmotic flow. Using bare-fused silica, CE-VSSI-MS separations of β-blockers are achieved using an ammonium acetate background electrolyte at pH 6.3 that provides an electroosmotic flow. The capillary electrophoresis separations are compatible with electrokinetic injections and electrokinetic stacked injections to achieve a linear range of 10 to 1000 nM and 1 to 100 nM, respectively. Additionally, sheath flow CE-VSSI-MS can be performed where the electroosmotic flow is suppressed using a 2% formic acid background electrolyte to separate and detect amino acids within a concentration range of 0.25 to 5 μM. Moreover, the electroosmotic flow is also suppressed using a semipermanent coating to separate anionic nonsteroidal anti-inflammatory drugs (NSAIDs). The separation is achieved at near-neutral pH with reversed polarity. Under these operating conditions, NSAIDs are detectable within a concentration range of 0.1 to 0.5 μM using electrokinetic sample stacking. The detection of the anionic analytes with VSSI-MS is achieved with positive mode MS, which demonstrates a 3 order of magnitude enhancement in signal relative to that observed in negative mode MS.

Materials and Methods

Materials and methods described herein are specific examples introduced merely in relation to demonstrations and experiments discussed below and should not be viewed as limiting the scope of the claims.

Chemicals and Reagents. An amino acid kit (LAA-21), pindolol (P-0778), acebutolol (A-3669), atenolol (A-7655), timolol (T-6394), tolmetin (T-6779), ketoprofen (K-1751), suprofen (S-9894), indoprofen (I-3132), acetic acid (A6283), and mineral oil (M5904) were purchased from Millipore Sigma (Burlington, MA). Oxprenolol (156023) was purchased from ICN Biomedicals Inc. (Aurora, OH). Caffeine (C5-3) was purchased from Aldrich Chemical Co. LLC (Milwaukee, WI). Formic acid (A13285) and ammonium acetate (A16343) were purchased from Alfa Aesar (Heysham, England). Ammonium hydroxide (BDH3016) was purchased from VWR Analytical (Radnor, PA). The phospholipids 1,2-dimyristoyl-sn-glycero-3-phosphocholine (DMPC) and 1,2-dihexanoyl-sn-glycero-3-phosphocholine (DHPC) were from Avanti Polar Lipids (Alabaster, AL). Deionized water (18 MΩcm) was obtained from an Elga Purelab and Veolia Chorus water system (Lowell, MA).

VSSI Probe Fabrication. The bare fused silica sheath capillary with an inner diameter of 200 μm and outer diameter of 363±10 μm (TSP200350, Molex, Phoenix, AZ) is cut to 30 cm. The polyimide coating is removed on both ends of the capillary and examined with a microscope for a clean cut. To prepare the capillary electrophoresis electrode, a 25 μm platinum wire (PT005113, Goodfellow, Huntingdon, England) is trimmed to approximately 1 cm in length, bent at two 90° angles in a “U” shape, and fixed to the sheath using 1 minute epoxy (1366072, Henkel, Dusseldorf, Germany). To create the electric connection, the platinum is attached to a wire using conductive epoxy (8331-14G, MG Chemicals, Ontario, Canada) and then covered with a layer of 1 minute epoxy (1366072, Henkel). The hydrodynamic flow through the sheath capillary is driven by applying a pressure of 20 to 40 kPa (3 to 6 psi). The VSSI probe device is constructed using a solid glass rod (GR100-4 Precision Instruments 1 mm×10 cm), pulled using a laser puller (Sutter Instrument Company, Novato, CA), trimmed to a final tip diameter of approximately 60 to 100 μm, and attached to the underside of a piezoelectric transducer (7BB-27-4 LO, Murata diameter=27 mm) using 5-minute epoxy. The parameters used for pulling the glass rod to form the VSSI probe are as follows: HEAT=750, FIL=4, VEL=60, DEL=130, and PUL=50.

VSSI Instrumentation. The piezoelectric transducer is connected to a function generator (DDS signal generator/counter Koolertron, Hong Kong Karstone Technology Co, Hong Kong) and amplifier (7500, Krohn-Hite, Brockton, MA), and a square wave is applied with frequencies ranging from 92 to 96 kHz and amplitudes ranging from 10 to 12 Vpp. The applied frequency and amplitude vary between fabricated devices, and optimal settings are evaluated prior to use through visual observation of a microdroplet plume via a moistened cotton swab tip. A micromanipulator is utilized to position the VSSI probe at a 90° angle relative to the capillary. The VSSI probe is parallel to the platinum electrode at the end of the capillary. The sheath flow VSSI device is placed 2 to 3 mm from the inlet of the mass spectrometer. The alignment is evaluated by direct infusion of a standard compound (e.g., pindolol).

CE-VSSI-MS Separation and Analysis. Unless otherwise noted, the dimensions of the separation capillary are 30 cm, 25 μm inner diameter, and 150 μm outer diameter (TSP050150, Molex, Arizona, USA). Injection conditions, electric field, and separation polarity are noted in the text and figure captions. The acoustic spray is off during extensive pre-run flushes but remains active during shorter flushes in between runs. For the separations of beta blockers, prior to use, the capillary is flushed at 138 kPa (20 psi) with 0.1 N ammonium hydroxide for 60 min, water for 10 min, and the background electrolyte for 30 min. In between runs, the capillary is flushed for 1 min with background electrolyte. For the separations of amino acids, prior to use, the capillary is flushed at 138 kPa (20 psi) with 2% formic acid for 20 min. In between runs, the capillary is flushed for 1 min with background electrolyte. For the separations of NSAIDs, the capillary is treated with a semipermanent lipid coating. The procedure for coating the capillary involves a flush at 172 kPa (25 psi) with 0.1 N ammonium hydroxide for 30 min, deionized water for 15 min, methanol for 15 min, deionized water for 15 min, 50 mM ammonium acetate at pH 6.3 for 3 min, phospholipid coating for 20 min, and 50 mM ammonium acetate at pH 6.3 for 7 min. For all separations, the capillary used to split the flow for the sheath is 50 cm with an inner diameter of 200 μm (TSP050375, Molex, Arizona, USA), and the same background electrolyte solution is used. A Q-exactive mass spectrometer equipped with LTQ Tune Plus software (version 2.7) is used to collect the data (Thermo Fisher Scientific, San Jose, CA). Both the MS ion transfer tube and the capillary outlet are grounded, creating a field-free region. The instrument is operated with the VSSI source by overriding two interlocks for the standard HESI source and with the sweep gas cone removed. Data are processed using Thermo Fisher Scientific Xcalibur (version 4.1) and Microsoft Excel (2021, Microsoft, Redmond, WA).

Capillary Electrophoresis-UV (CE-UV) Absorbance Detection Separation and Analysis. All separations are conducted using a Beckman/Coulter P/ACE MDQ (Beckman Coulter, Fullerton, CA, USA). Capillaries have a total length of 40 cm, an effective length of 30 cm, an inner diameter of 25 μm, and an outer diameter of 360 μm. The capillary preparation and separation are the same as those used for the VSSI-MS analyses. To maintain the same electric field strength used on the CE-VSSI-MS system, the separation voltage was 21.3 kV, applied in normal polarity for the beta blocker and in reverse polarity for the NSAIDs, and 16 kV, applied in normal polarity for the amino acids. The analyses were performed using UV absorbance detection at a wavelength of 200 nm. The cartridge temperature is set to 25° C. for flushes and separations. Data collection and analysis are accomplished by the accompanying Beckman/Coulter P/ACE MDQ 32Karat Software (Beckman Coulter). It is worth noting that, in the CE-UV NSAID separations, capillaries are flushed in between runs for an additional 3 min with ammonium acetate, followed by 5 min of phospholipid, and then 3 min of background electrolyte at 172 kPa (25 psi).

Preparation of Phospholipid. The solutions of the phospholipids were prepared as previously described (Refs. 1-33-1-35). Briefly, DMPC and DHPC are weighed and combined at a molar ratio of 0.5 DMPC/DHPC. The 5% phospholipid solution is prepared by adding 50 mM, pH 6.3 ammonium acetate to the phospholipid powder. The preparation was then vortexed until the solids were thoroughly dissolved. The solution was then subjected to three freeze-thaw cycles followed by centrifugation at 10000 rpm for 10 min at 4° C. and stored at −20° C. Before use, calcium chloride was added to the lipid to a final concentration of 1 mM.

Results and Discussion

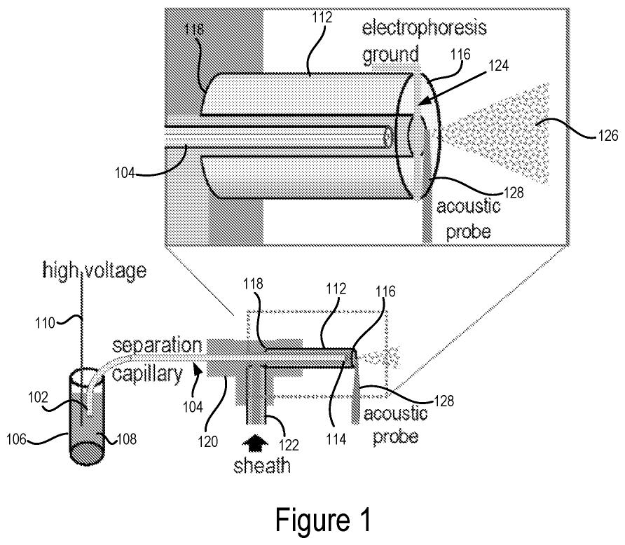

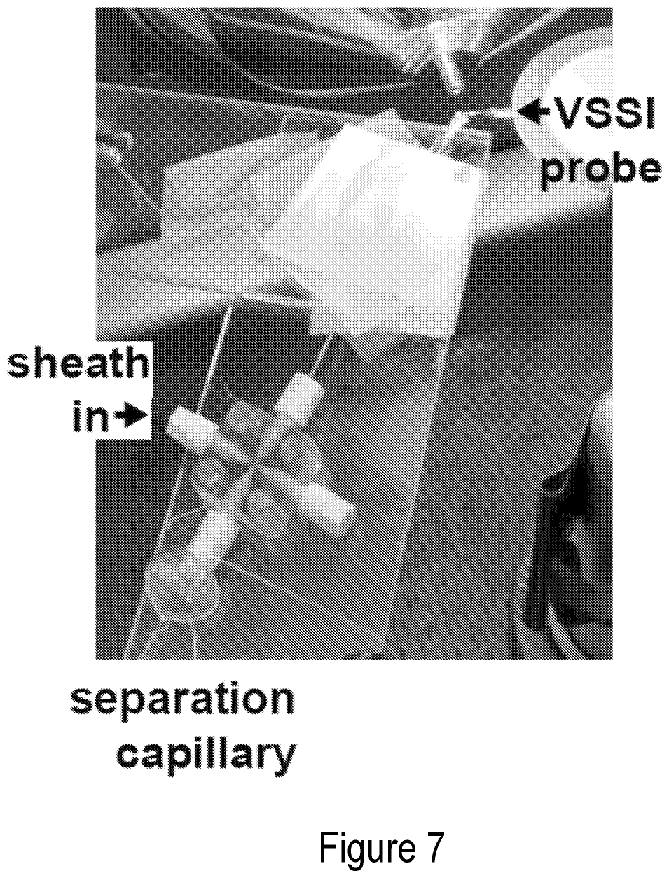

VSSI Interface Design. The VSSI interface design integrates a sheath flow that allows for stable VSSI nebulization and ionization. The sheath flow VSSI interface shown in FIG. 1 demonstrates that a separation capillary 104 is integrated inside of a sheath capillary 112. In this design, the VSSI interface operates independently of the capillary electrophoresis. The voltage applied to the separation capillary does not affect the ion intensity. The separation capillary is recessed less than 100 μm from the grounding electrode that is flush with the end of the sheath capillary. The use of the sheath overcomes the limitation of the previously reported sheathless design (Ref. 1-30) which required flow rates greater than 70 nL/min in the separation capillary. The sheath provides a stable sheath flow rate of 400 to 900 nL/min. With the aid of a camera, the VSSI probe is aligned directly at the sheath with micromanipulators (FIG. 7).

FIG. 1 shows a first example analysis apparatus 100. In particular, the first analysis apparatus 100 relates to a capillary electrophoresis (CE) with a VSSI interface. The combination of the CE and VSSI can be coupled with a mass spectrometer (MS). The first example analysis apparatus 100 includes the capillary electrophoresis apparatus including the separation capillary 104 having an injection end 102 and a distal end 114. The injection end 102 is configured to receive an analyte liquid 108 stored in an analyte reservoir 106. The analyte liquid 108 can include the analyte that is to be analyzed as well as an electrolyte, also referred to herein as background electrolyte or buffer. The first example analysis apparatus 100 also includes a sheath capillary 112 that covers the distal end 114 of the separation capillary 104. The sheath capillary 112 can have an inner diameter that is greater than the outer diameter of the separation capillary 104. In some examples, the inner diameter of the sheath capillary 112 can be greater than the outer diameter of the separation capillary 102 by about 25 micrometers to about 5 mm. The sheath capillary 112 can have a first end 116 and a second end 118. The first end 116 of the sheath capillary 112 is open to the MS, while the second end 118 receives the separation capillary 104. The sheath capillary 112 can be at least partially enclosed in a sheath cover 120 that provides structural stability to sheath capillary 112 and the separation capillary 104. The sheath cover 120 can be a T-junction conduit in which the main conduit accommodates the separation capillary 104 and the sheath capillary 112 and the branch conduit can accommodate a sheath capillary extension 122 that is coupled with the second end 118 of the sheath capillary 112. The sheath capillary extension 120 receives sheath fluid, which is provided to the second end 118 of the sheath capillary 112. This sheath fluid then flows from the second end 118 to the first end 116 of the sheath capillary 112. In some instances, the sheath capillary 112 and the sheath capillary extension 112 can be joined together at the second end 118 and can include an opening that allows the separation capillary 104 to pass through.

The separation capillary 104 can have a length, measured between the injection end 102 and the distal end 114, between about 5 cm and about 2 m. In some examples, the length of the separation capillary 104 can be between about 20 cm and about 2 m. In some examples, the inner diameter of the separation capillary 104 is between about 15 micrometers and about 35 micrometers, or about 10 micrometers to about 50 micrometers or about 10 micrometers to about 100 micrometers. In some examples, the separation capillary 104 can have a total volume of no more than about 8 micro-liters. In some examples, the separation capillary 104 can have a total volume of no more than 2 micro-liters. The total volume of the separation capillary 104 can be a function of the inner diameter and the length. As an example, the total volume of the separation capillary can be about 200 nano-liters. The distal end 114 of the separation capillary 104 can be positioned inwards from the first end 116 of the sheath capillary 112. Positioning the distal end 114 inwards from the first end 116 of the sheath capillary 112, can help in mixing the analyte liquid 108 exiting from the distal end 114 with the sheath fluid surrounding the sheath capillary 112 before the mixture is ionized by the acoustic probe. In some examples, the distance between the distal end 114 of the separation capillary 104 and the first end 116 of the sheath capillary 112 is less than 2 mm. In some examples, the distance between the distal end 114 of the separation capillary 104 and the first end 116 of the sheath capillary 112 can be less than 100 micrometers.

A ground terminal 124 can be positioned at the first end 116 of the sheath capillary 112. In particular, the ground terminal 124 can be positioned outside of the sheath capillary 112 at the edge of the first end 116. In some examples, the ground terminal 124 can be positioned at the first end 116 of the sheath capillary 112 but inside the sheath capillary 112. This can be done to position the ground terminal 124 closer to the distal end 114 of the separation capillary 104. A high voltage terminal 110 can be positioned in contact with the analyte liquid 108 in the analyte reservoir 106. A voltage difference between the high voltage terminal 110 (at the injection end 102) and the ground terminal 124 (at the distal end 114) can help maintain a flow rate of the analyte liquid 108 through the separation capillary 104. The high voltage terminal 110 and the ground terminal 124 can be coupled with a DC voltage source (not shown) that can provide a voltage difference of at least a few hundred volts and up to several hundred kilovolts. As an example, the flow rate of the analyte liquid 108 through the separation capillary 104 can be about 0 nano-liters to about 70 nano-liters.

An acoustic probe 128 configured to vibrate is positioned in contact with at least one of the first end 116 of the sheath capillary 112 or the distal end 114 of the separation capillary 104. The acoustic probe 128 can be coupled with a vibrating medium that provides vibrational motion to the acoustic probe 128. The vibrations caused by the acoustic probe 128 can cause the mixture of the stealth fluid and the analyte liquid 108 to nebulize and ionize and form a spray 126 that is directed towards the MS. In some examples, the acoustic probe 128 may be in indirect contact with the at least one of the first end 116 of the sheath capillary 112 or the distal end 114 of the separation capillary 104. That is, the acoustic probe 128 can be coupled with the sheath capillary 112 or the separation capillary 104 by an adhesive or binding material such as, for example, epoxy or polymer.

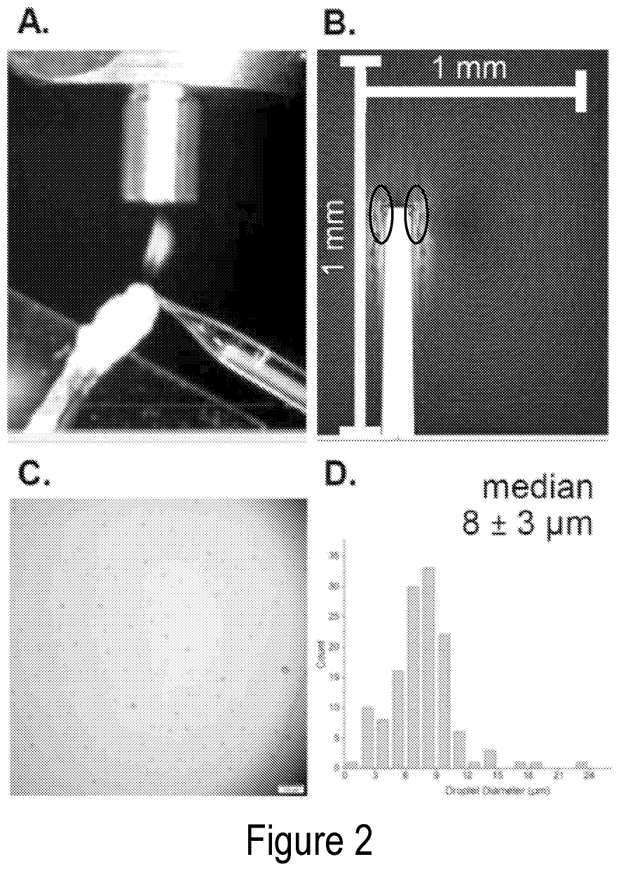

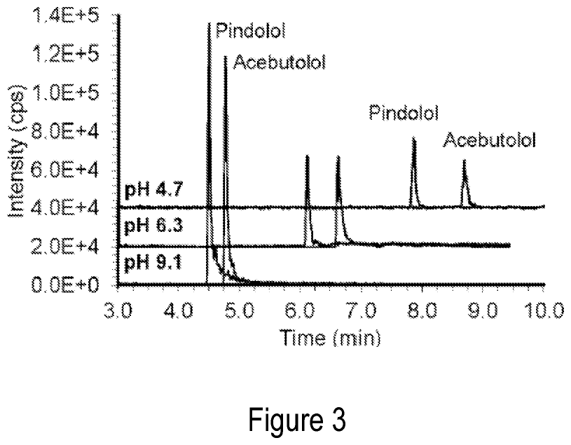

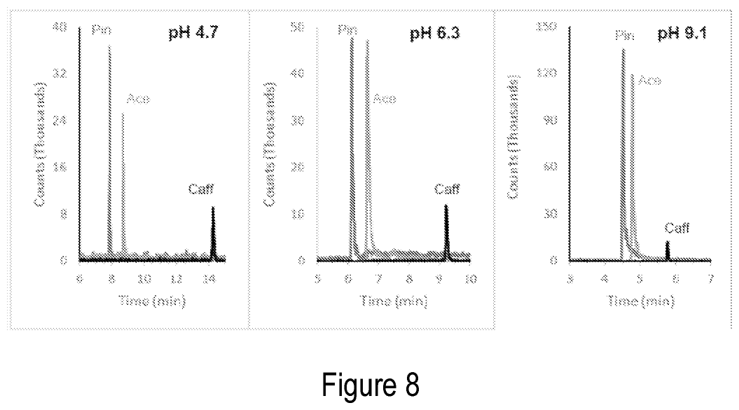

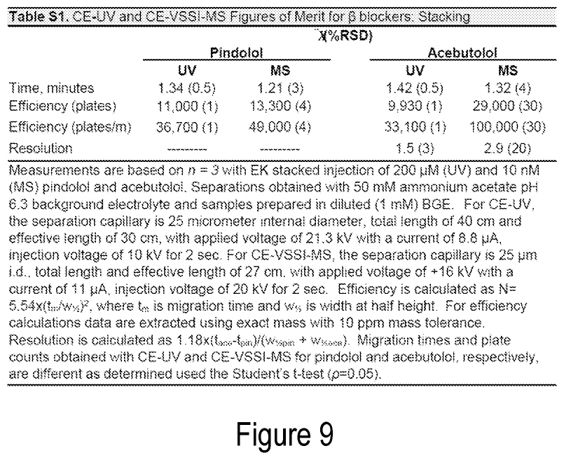

VSSI Droplet Formation. In some examples, the capillary electrophoresis-VSSI spray 126 is ejected at an angle and creates droplets that are approximately 8 μm in diameter. This angular direction of spray observed with sheath flow VSSI (FIG. 2A) was also reported with sheathless VSSI. This spray orientation and the 1 mm size of the plume are similar to the results obtained through COMSOL modeling of the acoustic streaming shown in FIG. 2B. The numerical simulation indicates that the maximum streaming velocity resides on the corner edge at the tip of the vibrating capillary, denoted with ellipses in FIG. 2B. This location is where the droplets are most probably ejected into to the air. The interaction of fluid with the vibrating probe likely forms streaming that, along with plume entrainment and the MS vacuum intake, leads to the angular appearance of the spray. Streaming was also visualized a separation of pindolol and acebutolol is performed using a sheath flow CE-VSSI-MS system with sheath and separation background electrolyte simultaneously maintained at a pH of 4.7, 6.3, or 9.1. Pindolol and acebutolol, which are cationic beta blockers, are resolved by utilizing ammonium acetate as the background electrolyte at acidic, near-neutral, and basic pH using sheath flow CE-VSSI-MS (FIG. 3). These data are obtained with a 20 μm inner diameter separation capillary for which the calculated volumetric flow rate of the separation ranges from 11 to 27 nL/min. This is determined using caffeine as a neutral flow marker (FIG. 8). These data demonstrate stable VSSI spray with capillary electrophoresis separations with sub-70 nL/min flow rates over a wide pH range. While resolution is higher at low pH where the electroosmotic flow is slower, faster analyses are possible at higher pH. Although it appears from FIG. 3 that the signal intensity increases with pH, it is important to note that greater mass loading is obtained with electrokinetic injections performed with increasing pH. For example, the mass loading calculated at pH 4.7, 6.3, and 9.1 for an electrokinetic injection of 1 μM pindolol is 81, 110, and 140 fg, respectively, and for acebutolol, it is 100, 130, and 180 fg, respectively. This increase in mass loading corresponds directly with the increase in peak areas obtained at pH 4.7, 6.3, and 9.1.

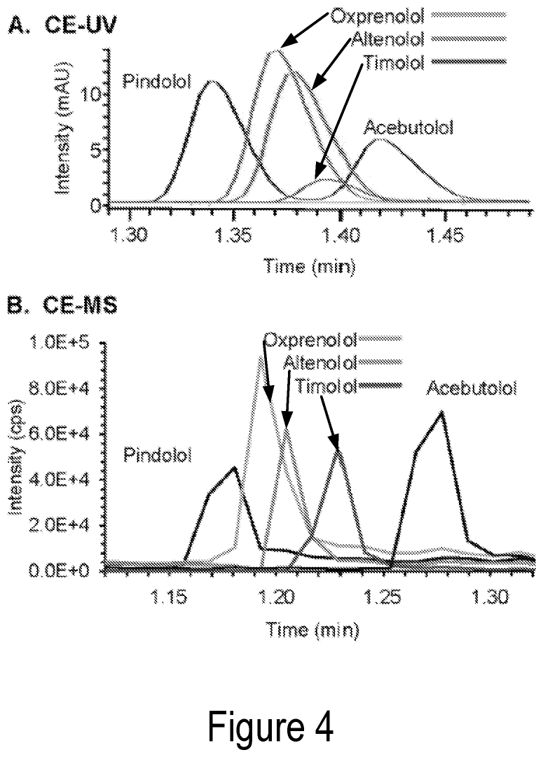

Separation Performance. Thorough characterization of the nanoflow sheath system with beta blockers is performed using electrokinetically stacked injections and the near-neutral pH background electrolyte, which has an intermediate electroosmotic flow rate. The traces for both the CE-UV and CE-VSSI-MS, shown in FIG. 4, are each 0.2 min wide with the trace for the CE-VSSI-MS being from a single run as compared to multiple runs superimposed onto each other with CE-UV. The CE-VSSI-MS distinguishes oxprenolol, atenolol, and timolol that comigrate in the capillary electrophoresis separation (FIG. 4). Migration times obtained with CE-UV and CE-VSSI-MS are significantly different as determined with a Student's t test (p=0.05). However, this is attributed to the use of a slightly higher electric field strength and the absence of temperature control on the lab-built CE-VSSI-MS instrument as separations performed on the CE-UV instrument had migration times as much as 8 s faster at 31° C. than runs obtained at 25° C. (Table S2). Additionally, the lab-built CE-VSSI-MS instrument had higher variance in migration time as the runs are manually controlled. The theoretical plate counts achievable with the capillary separation do not decrease with the introduction of the CE-VSSI-MS nanoflow sheath. The linear response for CE-VSSI-MS is 1-100 nM compared to 10-1000 μM for CE-UV (Table S3).

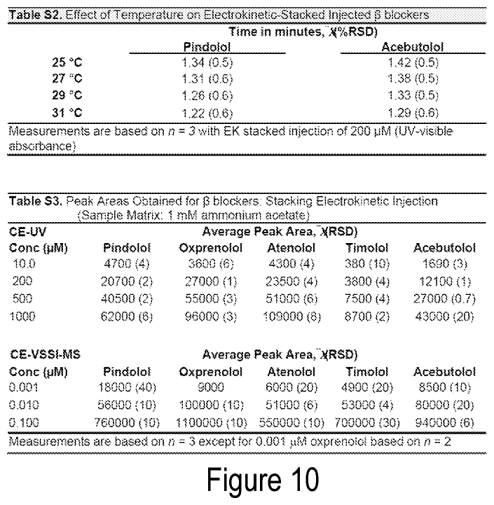

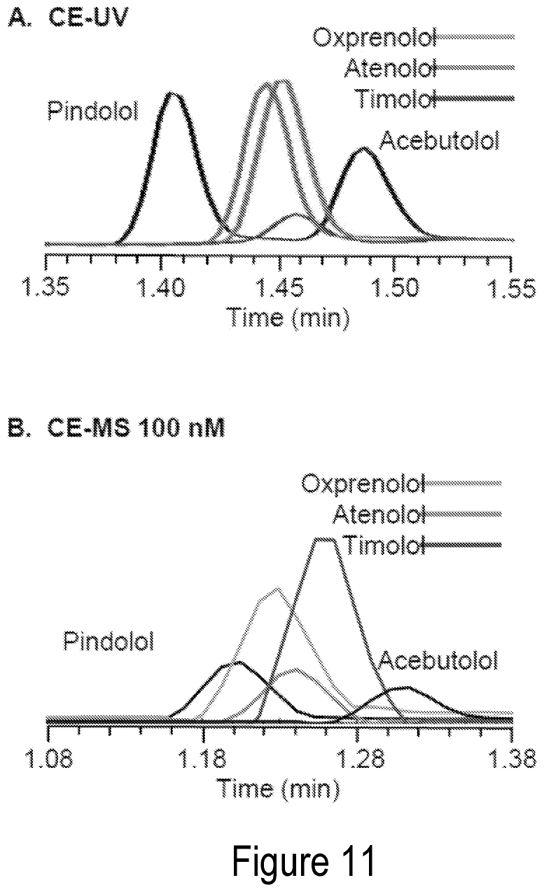

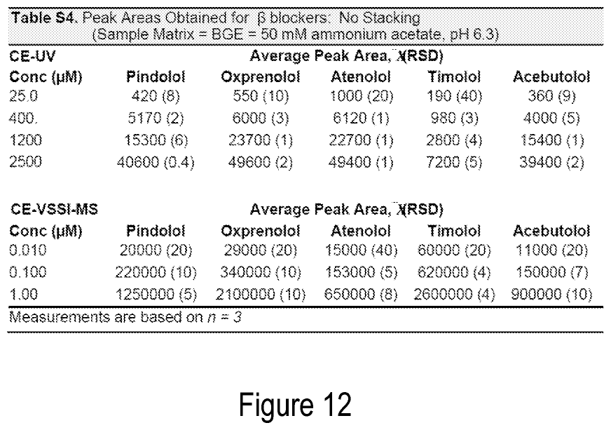

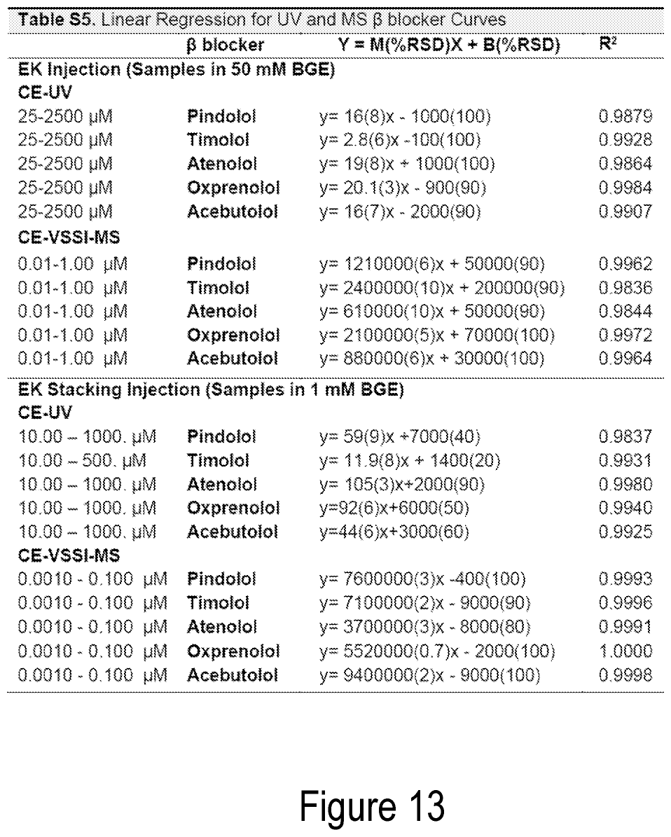

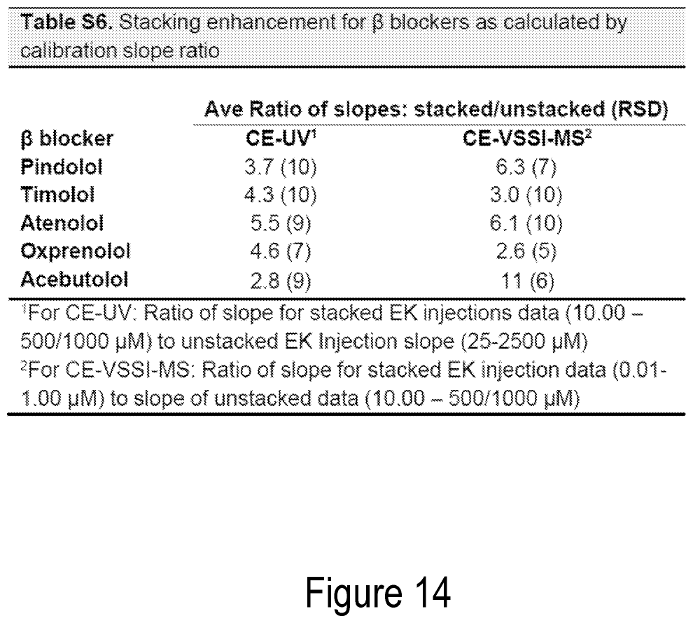

Stacking Enhancement. Nanoflow sheath (e.g., the sheath capillary 112) is compatible with both electrokinetic injections (FIG. 11) and stacked electrokinetic injections (FIG. 4). The linear range for EK injections of beta blockers begins at a lower concentration for CE-MS compared to CE-UV (25-2500 μM for CE-UV and 0.010-1.0 μM for CE-VSSI-MS; see Table S4 in FIG. 12 and Table S5 in FIG. 13). This is also observed for EK stacked injections with a CE-UV linear range of 10.00-500/1000 μM and a CE-VSSI-MS linear range of 0.0010-0.10 μM (Tables S3 shown in FIG. 10 and Table S5 shown in FIG. 13). For CE-VSSI-MS, an injection voltage of 20 kV is applied for 2 s, and for CE-UV, an injection voltage of 10 kV for 2 s is used. A lower injection voltage is used in one example CE-UV analysis because 10 kV is the maximum injection voltage of the commercial instrument. To compare the stacking enhancement, a ratio of the slope of the curves generated from peak areas obtained with stacking electrokinetic injection to non-stacking electrokinetic injections is taken (Table S6 shown in FIG. 14). For the CE-VSSI-MS stacked injections, the signal intensity is increased by 3-12-fold depending on the analyte, as compared to CE-UV for which stacking enhancement is 3-6-fold.

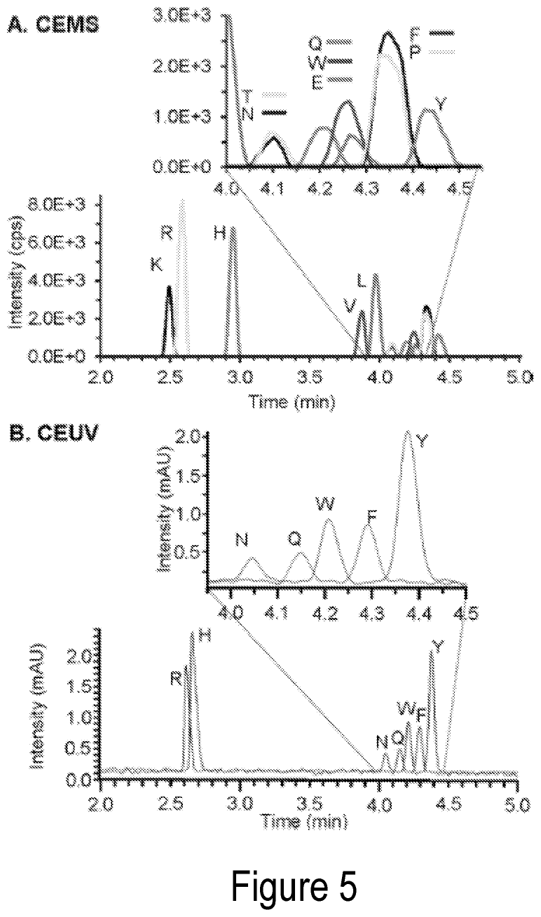

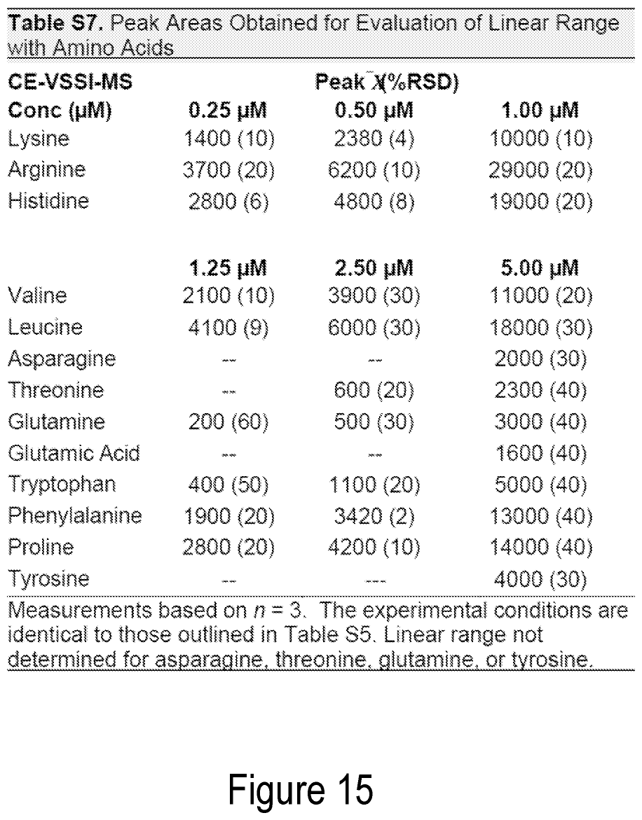

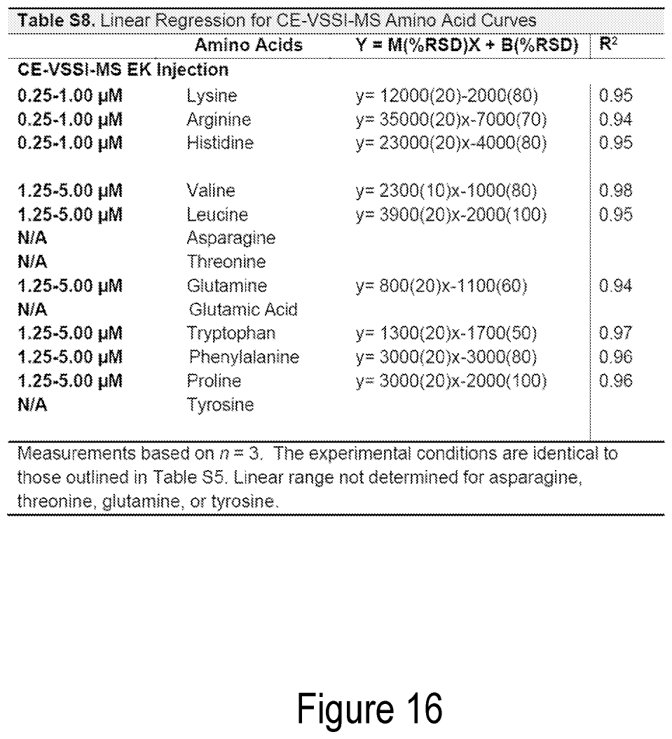

CE-VSSI-MS Separations of Amino Acids with Suppressed Electroosmotic Flow. CE-VSSI-MS is not only useful for the separation of cationic beta blockers but also applicable to compounds that require an acidic background electrolyte to remain cationic. The separation of amino acids is performed using a background electrolyte composed of 2% formic acid, similar to CE-ESI-MS separations of amino acids reported in the literature (Ref 1-37). Under these conditions, the electroosmotic flow is suppressed; therefore, the analyte migration is predominantly due to electrophoretic mobility. The sheath design enables MS detection of analytes regardless of the electroosmotic flow rate. With CE-VSSI-MS, 13 amino acids are separated and detected in under 5 min. The separation of amino acids shown in FIG. 5A is performed using a stacked electrokinetic injection of 20 kV for 3 s in a single analysis of a sample containing a mixture of 1 μM lysine, arginine, and histidine as well as 5 μM valine, leucine, asparagine, threonine, glutamine, tryptophan, glutamic acid, phenylalanine, proline, and tyrosine all dissolved in 0.004% formic acid. These amino acids are detectable at concentrations ranging from 0.25 to 5.0 μM (Tables S7 and S8 shown in FIGS. 15 and 16, respectively). These concentrations are comparable to those recently reported for CE-ESI-MS systems with microliter (Refs. 1-38-1-39) or sub-microliter (Refs. 1-40-1-41) sheath flows. While these reported systems utilized organic solvents (Refs. 1-38-1-41) in the sheath fluid, no organic solvents are needed with VSSI. The low molecular weight amino acids alanine and glycine are poorly detected with the MS and therefore not included. Additionally, isoleucine comigrates with its isomer leucine and is indistinguishable by MS.

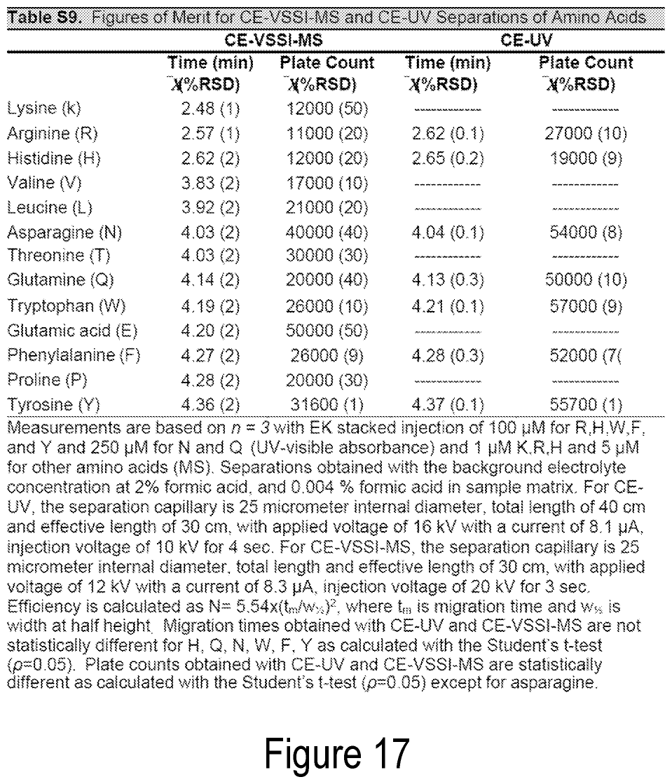

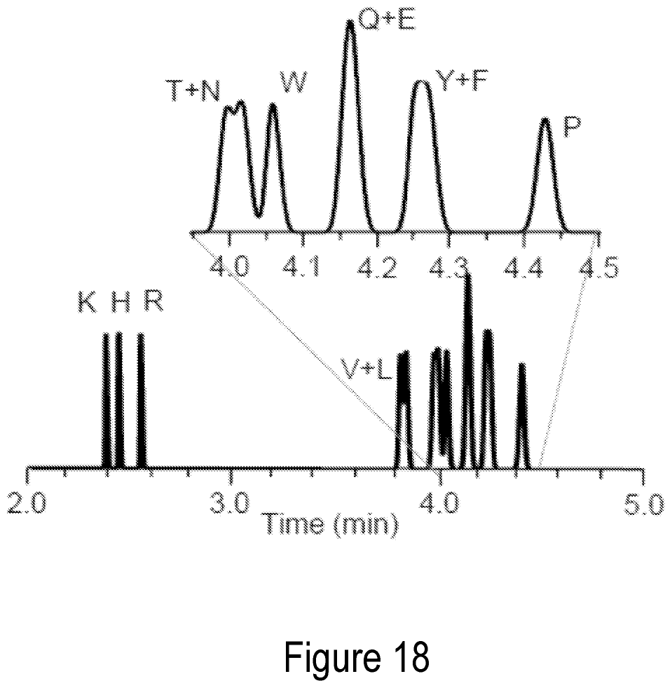

CE-VSSI-MS vs CE-UV. The separation performance with CE-VSSI-MS of amino acids can be compared using separations obtained with the same conditions but detected with UV absorbance detection. For CE-UV, only 7 of the 13 amino acids are detected with an electrokinetic stacking injection at 10 kV for 4 s. Also, because of peak overlap with CE-UV, full visualization of analyte peaks with UV requires two separate runs, which are then superimposed as shown in FIG. 5B. The CE-UV traces are obtained at a concentration of 100 μM arginine, histidine, tryptophan, phenylalanine, and tyrosine and 250 μM asparagine and glutamine. While the migration times of the CE-VSSI-MS and CE-UV separations are statistically the same, the plate counts obtained with CE-UV are greater than those of CE-VSSI-MS (Table S9 shown in FIG. 17). This is due to injection overloading that occurs with the larger CE-VSSI-MS injections. As many of the amino acids are not detectable with UV absorbance, a simulation of the separation is used to predict the migration order for the amino acids that are undetectable with UV-visible absorbance (FIG. 18). The simulation has comparable separations although tryptophan and proline migrate slower than predicted and arginine migrates faster than predicted by the simulation.

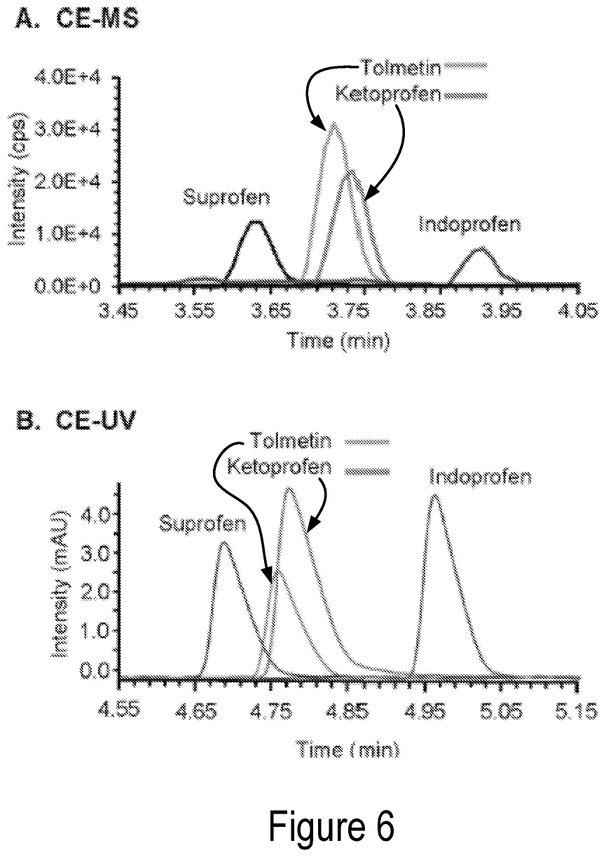

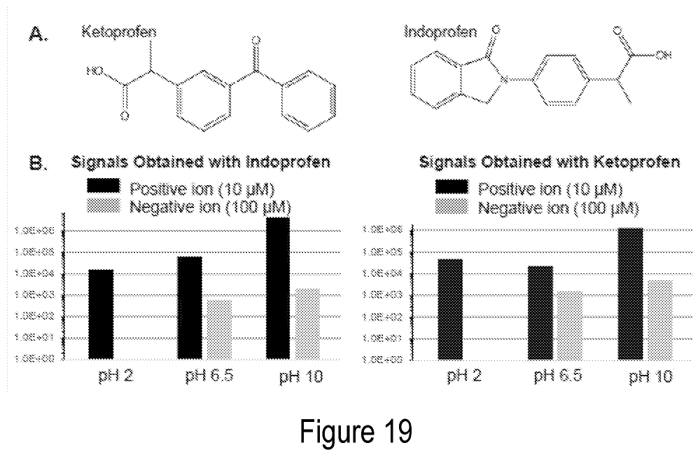

CE-VSSI-MS Separations with a Modified Capillary Surface and Reversed Polarity. The flexibility of the nanoflow sheath CE-VSSI-MS enables the use of reversed polarity with a suppressed electroosmotic flow to resolve the anionic NSAIDs. The passivation of the inner capillary wall surface of the separation capillary 104 can be accomplished using a previously reported semi-permanent capillary surface coating (Refs. 1-42-1-44) that masks the surface charge on the fused silica through the self-assembly of a phospholipid and is stable in solutions ranging in pH from 4 to 8. A benefit of the use of this reversed polarity separation is that it enables sample stacking of anions, which increases the peak height and area. The CE-VSSI-MS analysis of NSAIDs shown in FIG. 6A is obtained in positive ion mode rather than with negative ion mode as a larger MS signal is observed. Experiments conducted with direct infusion reveal that this effect on the ionization efficiency of positive ions is more pronounced with higher pH (FIG. 19). The increase in positive ionization efficiency is consistent with enhanced ionization associated with ammonium ions to either protonate the NSAID or form a transient adduct, which assists in ionization (Refs. 1-45-1-47).

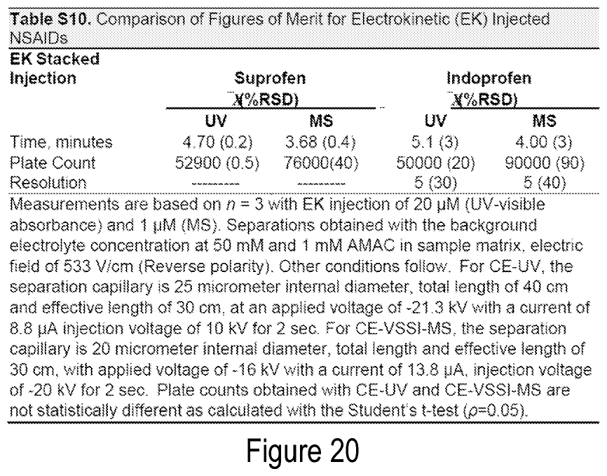

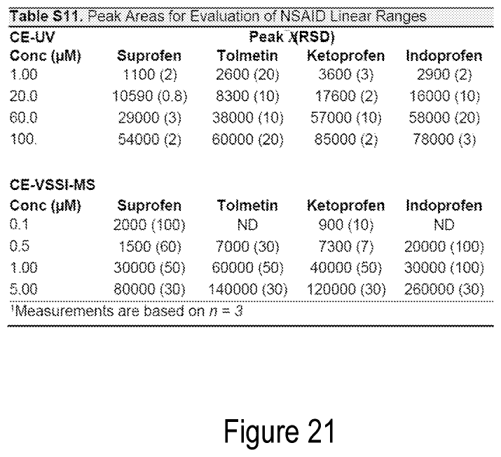

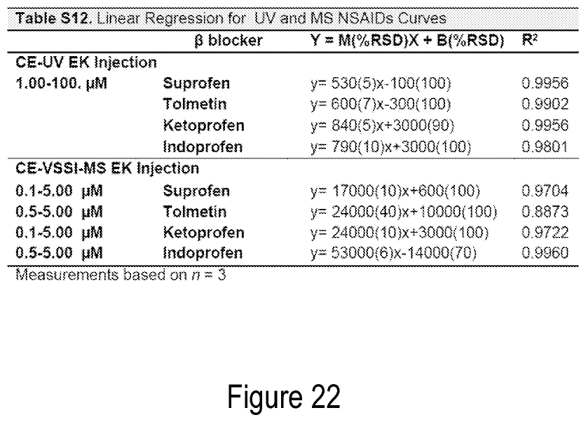

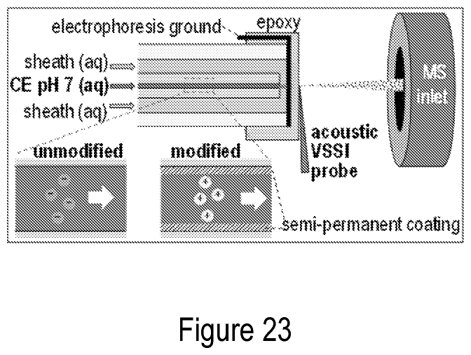

The CE-VSSI-MS separation of NSAIDs is obtained in a single run (FIG. 6A), but the CE-UV analyses are completed in multiple runs, which are superimposed (FIG. 6B). The migration times for CE-UV and CE-VSSI-MS are different (Table S9 shown in FIG. 17), which is attributed to a lack of temperature control in the lab-built CE-VSSI-MS system and the use of flushing and recoating of the programmable CE-UV capillary, which is not performed with the CE-VSSI-MS system. Moreover, the CE-VSSI-MS data display an increase in the separation current over time. This can potentially be attributed to a change in ion balance from the sheath capillary 112. Although the migration times differ, the separation efficiency is the same for CE-VSSI-MS and CE-UV. The linear range of the CE-UV is 1 to 100 μM, whereas the CE-VSSI-MS linear range is from 0.1 or 0.5 to 5 μM (Tables S10 and S11 shown in FIGS. 20 and 21, respectively). Previous CE-ESI-MS reports have a similar sensitivity. For example, a nanoflow sheath CE-ESI-MS analysis also based on positive mode MS and an aqueous background electrolyte had a detection limit of 4 μM for ketoprofen (Ref. 1-48). In a different report (Ref. 1-49) a detection limit of 0.4 μM was obtained for suprofen with negative mode MS using a sheath flow interface and an aqueous background electrolyte. The detection of the NSAID suprofen was improved when a nonaqueous background electrolyte 49 was used with sheath flow and sheathless flow, generating 0.2 and 0.004 μM, respectively.

The apparatus and methods described herein provide aspects of a nanoflow sheath CE-VSSI-MS design. Using this design, the separation can be performed using background electrolyte at different pH values regardless of flow rate in such a manner that high separation voltage and rapid separation can be achieved. The results achieved by this system are comparable to those achieved by the previously reported sheathless CE-VSSI-MS, and analyte is detected without a significant dilution effect. The nanoflow sheath design offers the flexibility to select different volatile background electrolytes for the separation and analysis of small cationic, zwitterionic, and anionic compounds. Moreover, separation of these analytes via the nanoflow sheath is achieved with an untreated fused silica capillary as well as a capillary surface modified with a semipermanent lipid coating. Signal enhancement is realized by the stacked injection of the analytes.

Protein Analysis Using CE-VSSI-MS

Capillary electrophoresis interfaced to mass spectrometry with electrospray ionization typically incorporates additives that are acidic or comprised of organic solvents to assist in the ionization process. Vibrating sharp-edge spray ionization (VSSI) is a voltage free method of ionization to interface capillary electrophoresis and mass spectrometry that does not require these additives, making it more suitable for a wide range of protein analyses. Additionally, when a nanoflow sheath capillary electrophoresis system is interfaced to the mass spectrometer, the separation can be performed under low and even zero flow conditions. In this report, a nanoflow sheath and capillary separation are performed with aqueous solutions and interfaced to mass spectrometry through VSSI. To accomplish these separations semi-permanent coatings comprised of self-assembled lipids are used to overcome surface adsorption and to facilitate electrophoresis at a neutral pH. Using low ionic strength aqueous solutions in the sheath fluid reduced signal suppression while including serine in the sheath fluid reduced analyte adduction. Capillary electrophoresis-VSSI separations of anionic proteins are easily detected in the 2.5-10 μM range. The anionic proteins β-lactoglobulin and transferrin are resolved using an unmodified fused silica separation capillary because they do not exhibit non-specific surface adsorption. Conversely, separations of cationic proteins cytochrome c, ribonuclease A, and α-chymotrypsinogen A are more difficult to achieve, owing to non-ideal surface interactions. With an unmodified capillary, the cationic protein separations required acidic background electrolytes to reduce electrostatic interactions. Alternatively, separations of cationic proteins are achievable at neutral pH with semi-permanent coatings based on a self-assembled zwitterionic lipid coating as well as a hybrid cationic lipid coating. These results demonstrate the potential of capillary electrophoresis-VSSI as a biotechnology tool to support protein analyses under physiologically relevant conditions.

Capillary electrophoresis (CE) technologies are powerful tools for analyses of protein therapeutics, (Ref 2-1, 2-2) protein interactions, (Ref 2-3) and can provide insight into complex protein systems that are foundational to life processes. (Ref 2-4). The simplest analyte separations are based on differences in the charge-to-size ratio (i.e. free solution electrophoresis) or on size-based sieving through gel matrices. In addition to these separation modes, CE analyses can be modified to provide information about protein activity and protein affinity. (Ref. 2-5). CE separations are exceptionally fast.6 These separations are critical to nano and microscale biological applications because approximately 1 nL of sample is consumed. The sample volume is low in order to avoid excessive band-broadening associated with the injection, stipulating an upper limit of 3% of the total capillary volume. (Ref 2-7). As a result, the concentration sensitivity of CE is higher than that typically achieved with LC-MS interfacing. The exceptionally low sample consumption of CE means that analysis of a 1 nL injected zone of a 5 μM solution of a protein with a molecular weight of approximately 20,000 Da results in loading a 0.15 ng mass of protein into the separation capillary. Although the sample mass loading is low, it is compatible with several modes of detection, including mass spectrometry (MS).

The synergy between CE and mass spectrometry has driven interfacing with electrospray ionization (ESI). Many of these CE applications benefit from coupling to MS detection which provides a means to conclusively identify protein structures by the combination of migration time and m/z values. Moreover, MS analyses differentiate protein isoforms, identify post translational modifications, and resolve protein conformations. (Ref 2-8, 2-9). Since the earliest reports of the use of ESI with CE, (Ref. 2-10, 2-11) both sheathless and nanoflow sheath designs (such as e.g., the first example analysis apparatus 100 discussed above in relation to FIG. 1) have quantitatively demonstrated improved sensitivity. (Ref 2-12). New designs that are sheathless or that integrate a sheath flow have been reported to decouple the electrophoresis and ESI currents. (Ref. 2-13) This decoupling is achieved in sheathless systems by connecting a conductive fluid to a capillary channel through a variety of techniques that breach the silica tubing including a porous region in the silica, (Ref 2-14) fractures, (Ref 2-15) laser-drilled holes, (Ref 2-16) and low to zero flow liquid connections. (Ref 2-17). To address the effects of analyte dilution, sheath flow systems are designed to operate at flow rates less than 1 μL/min achieved with electrokinetic pumping18 or hydrodynamic flow. With a sheath flow system, acidic or organic solvents can be introduced to assist the ionization process, provided that these solvents are appropriate for the application. (Ref. 2-13). Beyond the need for considering solvent compatibilities, the effects of surface adsorption and the control of electroosmotic flow must also be addressed. (Ref. 2-19, 2-20). As a result, multiple factors influence CE method development for protein analyses, including methods intended to mimic the physiological environment.

To date, a handful of CE-ESI-MS analyses of proteins have been performed under native conditions using both sheathless and sheath flow systems. The sheathless interfaces use commercially available instrumentation including capillaries with a modified surface and a porous frit for antibodies (Ref 2-21, 2-22) and large DNA-histone complexes comprising endogenous nucleosomes. (Ref 2-23). The separations are achieved with volatile ammonium acetate electrolytes prepared at, or near, a neutral pH. A conductive liquid, generally comprised of acetic acid, completes the separation circuit without interacting with the protein samples in the separation capillary. The electrophoresis run times for these sheathless systems extend to about 30 minutes. (Ref. 2-21-2-23). The separation is often performed with a superimposed pressure, (Ref 2-21, 2-23) which reduces the separation efficiency (Ref. 2-23, 2-24) because of the band broadening associated with the additional laminar flow. Similar to the sheathless interfaces, the sheath flow CE-ESI-MS analyses of proteins performed under native conditions are based on commercially available instrumentation and separation capillaries that have been modified to eliminate electroosmotic flow. For example, analyses achieved with capillaries modified with a linear polyacrylamide have demonstrated separations of the 70S ribosome complex from E. coli, (Ref. 2-25) proteoforms from E. coli lysate, (Ref. 2-26) and for antibodies. (Ref 2-27). These separations required a superimposed pressure ranging from 0.5 to 1 psi. For the analyses of proteoforms and the 70S ribosome complex, the CE separation times ranged from 6026 to 9025 min. For the focusing experiments the total time for the pre-separation focusing step and separation was 40 min. (Ref. 2-27).

VSSI is an electric field-free alternative to interfacing separations with MS. The interface is operated under ambient conditions and the nebulization process is driven by focusing acoustic energy at a sharp edge. Probe-based liquid interfacing has been coupled to flow rates ranging from 20 to 30 μL/min for the detection of small molecules, (Ref. 2-28-2-32) peptides, (Ref 2-31) DNA (Ref 2-31, 2-33) and proteins. (Ref. 2-31, 2-33-2-35). The geometry and configuration of pulled glass capillary VSSI probes have been adapted to accommodate sub-microliter flow rates inherent in CE. (Ref 2-36, 2-37). The VSSI interfacing has been directly coupled with CE separations in both a sheathless format36 and in a sheath flow design. (Ref 2-37). The sheathless capillary design transfers the analyte bands, generally in the picogram quantities, directly to the MS. This requires a minimum bulk electroosmotic flow of 70 nL/min to sustain the nebulization process. This limitation in the flow rate is overcome when a 400-900 nL/min sheath flow is integrated in the system, allowing the user to develop separations with suppressed and even zero-flow electroosmotic flow. (Ref 2-37). CE separations are achievable for anionic proteins resistant to surface adsorption and in the presence of a bulk electroosmotic flow. (Ref 2-36). These conditions are not applicable to all proteins because the silica surface introduces non-specific adsorption that reduces the separation efficiency or changes the protein structure; for example, through denaturation. These challenges can be overcome by leveraging both CE-VSSI-MS and coating technology, leading to greater flexibility in protein separations with CE-MS technologies.

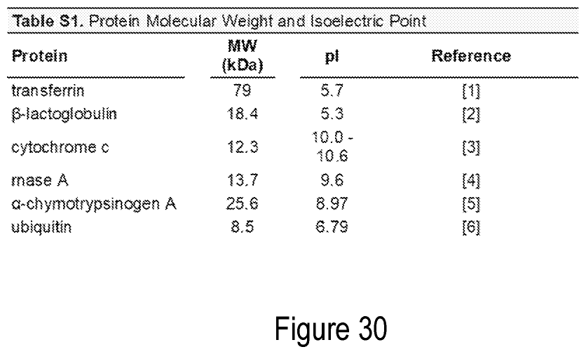

The techniques discussed herein provide alternative interfacing strategies for protein analyses by CE-MS. The results outlined herein demonstrate that while the ionization process inherent in VSSI is pH independent, it can be important to render the electrophoretic separation pH independent. Moreover, the composition of the sheath fluid can affect the ion suppression and formation of adducts. Proteins of different isoelectric points and molecular mass were evaluated (See e.g., Table S1 shown in FIG. 30). CE-VSSI-MS separations of anionic proteins are easily detected in the 2.5-10 μM range. These anionic proteins are resolved using an unmodified separation capillary because they do not exhibit non-specific surface adsorption on a bare fused silica surface. Conversely, separations of cationic proteins are more difficult to achieve owing to non-ideal surface interactions. Cationic proteins are resolved with the CE-VSSI-MS system by using acidic background electrolytes to reduce electrostatic interactions. An alternative approach is the use of semi-permanent coating strategies that mitigate surface interaction. This is demonstrated with CE-VSSI-MS using both a net neutral lipid coating to eliminate electroosmotic flow as well as a hybrid cationic lipid coating that introduces a bulk electroosmotic flow toward the MS inlet. Both coating strategies overcome the challenge of nonspecific surface adsorption of cationic proteins. These results demonstrate the potential of CE-VSSI-MS as a biotechnology tool to support protein analyses under conditions relevant to physiological conditions.

Materials and Methods

Chemicals and reagents. Acetic acid, ammonium acetate (431311), α-chymotrypsinogen A (C4879), cytochrome c (C3131), β-lactoglobulin (L0130), ribonuclease A (R5500), transferrin (T8158), and ubiquitin (U6253) were purchased from Sigma Aldrich (St. Louis, MO). The 4-methylmorpholine (A12158.AP) was purchased from Thermo Fisher Scientific (Waltham, MA). Cetyltrimethylammonium bromide (CTAB) was purchased from Acros Organics (Geel, Belgium). The phospholipids 1,2-dimyristoyl-sn-glycero-3-phosphocholine (DMPC) and 1,2-dihaxanoyl-sn-glycero-3-phosphocholine (DHPC) were purchased from Avanti Polar Lipids (Alabaster, AL). Deionized water is supplied from an ELGA Purelab and Veolia Chorus I (Lowell, MA).

Sample and solution preparation. Protein powder stocks were dissolved in 50 mM ammonium acetate to the desired stock concentration. The anionic proteins transferrin and β-lactoglobulin and cationic proteins α-chymotrypsinogen A and ribonuclease A were desalted prior to analysis on the unmodified capillary using molecular weight cutoff filters (UFC5010 Millipore Sigma, Allentown, PA). Briefly, the filter was conditioned with 50 mM ammonium acetate. The protein stock was loaded onto the filter and spun down 1-5 times, depending on the protein (14000 g 10 min 19° C.), with 50 mM ammonium acetate. The protein was recovered from the column with an inverted spin (1000 rpm 3 min 19° C.). All proteins were analyzed on a NanoDrop 1000 Spectrophotometer (Thermo Fisher Scientific, Waltham, MA) to determine the true concentration. Protein stocks were diluted into deionized water for analysis. Preparation of the phospholipid coating has been previously reported.38 The CTAB solution was prepared from powder stock daily using 50 mM ammonium acetate.

Capillary electrophoresis. The electrophoresis capillary has a 25 μm inner diameter and a total length of 30 cm, resulting in a total volume of 150 nL for the separation channel. Capillaries were conditioned prior to use. For bare-fused silica analyses, the capillary is flushed 30 min with 0.1 N ammonium hydroxide, 15 min with water, and 15 min with background electrolyte at 172 kPa (25 psi). Phospholipid coating is applied to the capillary by flushing 3 min with background electrolyte, 20 min with phospholipid, and 3 min with background electrolyte at 172 kPa (25 psi). CTAB coating is applied to the capillary after the phospholipid coating by flushing 7.5 min with background electrolyte, 7.5 min with phospholipid nanogel, 7.5 min with 100 μM CTAB, and 7.5 min with background electrolyte at 172 kPa (25 psi).

VSSI probe fabrication. Solid glass rods (GR100-4 Precision Instruments 1 mm×10 cm) were laser pulled (Sutter Instrument Company, Novato, Ca) under the settings HEAT=475, 650; FIL=4; VEL=60; DEL=130; PUL=50. The pulled probes are trimmed to a final outer diameter of approximately 50 μm. The probe is attached to the bottom of a piezoelectric transducer (7BB-27-4 LO, Murata, diameter=27 mm) using a 5-minute epoxy (14205 Devcon, Danvers, MA). The transducer is then attached to a function generator (bbs Signal Generator, Koolerton, Hong Kong) and amplifier (7500, Krohn-Hite, Brockton, MA). A square wave is applied to each probe and the operating frequency and amplitude range from 80-100 kHz and 0.09-0.10 V peak-to-peak (Vpp). An amplification of 100× provides a Vpp of 9-10 V. The exact frequency and applied voltage used for each probe varies and is established by observing the spray achieved by contacting the probe with a wet cotton swab.

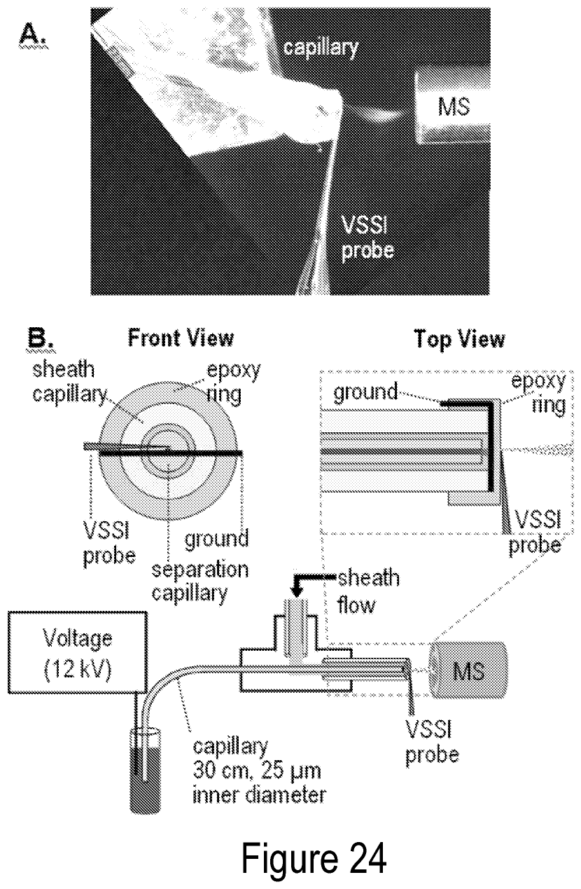

CE-VSSI-MS interfacing and instrumentation. The CE-VSSI-MS nanoflow sheath design has been previously characterized in relation to at least FIG. 1. (Ref 2-37). A platinum electrode is attached to the end of the sheath capillary at the outlet (FIG. 24B). The open platform CE-VSSI system is interfaced with the Q Exactive mass spectrometer (Thermo Scientific, San Jose, CA, USA) with the HESI source and sweep gas cone removed. Because the instrument will not operate with the HESI source removed, an analog connector and pin are used to override the source interlocks, enabling MS detection. The temperature of the MS inlet is set to 350° C. As VSSI is voltage free, no spray voltage is applied. Alignment of the VSSI probe to the capillary is accomplished using a micromanipulator under a magnifying camera. The probe can be angled between about 80 degrees and 125 degrees in relation to the longitudinal axis of at least one of the separation capillary or the first end of the sheath capillary. In some examples, the probe is angled at 90° relative to the sheath capillary outlet and placed 2.5 mm from the MS inlet on average. The quality of the alignment is evaluated by observing the signal of a background electrolyte direct infusion at m/z 200-400. CE-VSSI-MS analyses were conducted with a lab-built CE system previously described. (Ref. 2-39). This instrument lacks temperature control, so to achieve a temperature close to 19° C. for coating, a portable air conditioning unit is directed toward the capillary. The separation is done at room temperature. Data are processed using Xcalibur™ version 4.1 (Thermo Fisher Scientific, Waltham, MA) and UniDec40 ver 5.0.2.

Results and Discussion

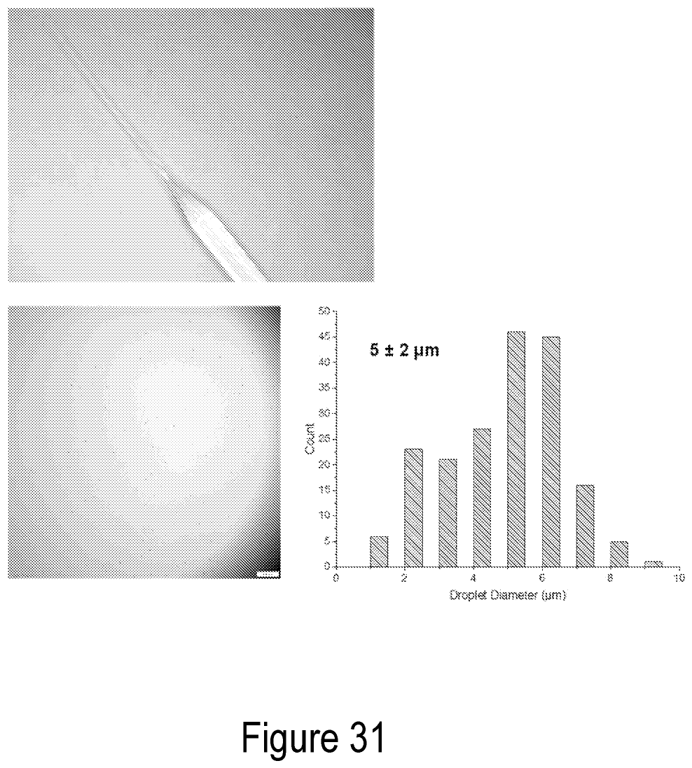

CE-VSSI-MS interfacing. The nanoflow sheath design implemented herein was previously characterized for small molecules as discussed above in relation at least to FIG. 1. (Ref 2-37). The VSSI probe spray is created with a glass probe pulled to a sharp tip to create small droplets. In some examples, the VSSI probe can terminate in an outer diameter of 54±3 μm and produce a plume of droplets of 5±2 μm in diameter (See e.g., FIG. 31). The VSSI probe is positioned across the capillary as shown in FIG. 1A, B. Also depicted in FIG. 1B, the separation capillary is threaded inside of the sheath capillary connected to through a t-cross junction and the electrophoresis ground is positioned at the end of the sheath capillary. This ensures that the separation voltage does not influence the field-free spray interface. An additional advantage of the sheath fluid flow, which is 600 nL/min, 37 is that it overcomes the previously reported minimum flow rate of 70 nL/min. (Ref 2-36). With both the separation and nanoflow sheath capillaries operating at a maximum flow rate, approximately 10% of nebulized solution originates from the separation capillary and 90% from the sheath capillary.

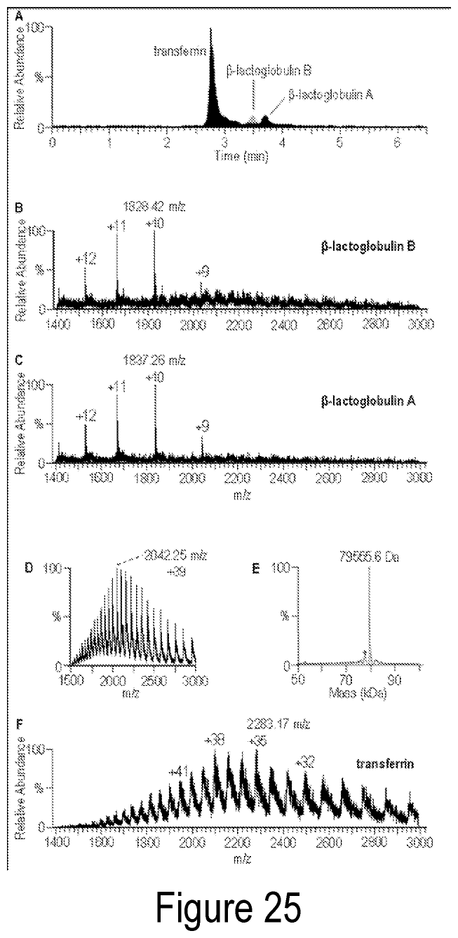

Separation of anionic proteins at pH 7.6 in an unmodified capillary. Separations of anionic transferrin (pI 5.7) and β-lactoglobulin variants (pI 5.3) can be accomplished using a background electrolyte buffered to pH of above 7 (e.g., 7.6) and an unmodified fused silica capillary because anions typically do not interact with the negatively charged silica surface. The extracted ion chromatogram in FIG. 25A is the first example of analysis of a protein mixture using nanoflow sheath CE-VSSI-MS. Runs that are achieved using a lab-built electrophoresis instrument interfaced to mass spectrometry have a relative standard deviation (RSD) in peak area and time less than 20% and 3%, respectively (n=3). For comparison, commercial CE instruments coupled to UV-absorbance detection have similar precision in optical detector response but have better precision in migration time with an RSD below 1%. The lab-built electrophoresis instrument has a higher variance in migration time resulting from manually controlled runs and a lack of temperature regulation.

An advantage of the CE separation (FIG. 25A) is that it resolves protein variants, like β-lactoglobulin A and B prior to MS detection. The CE-VSSI-MS analysis of transferrin at a concentration of 10 μM and of β-lactoglobulin variants at a combined concentration of 5 μM is comparable to CE-ESI-MS separations in the literature reporting detection of 20 μM transferrin41 and 27-186 μM β-lactoglobulin.42, 43 As depicted in the mass spectra in FIGS. 25B and 25C, β-lactoglobulin A (MW 18373.7 Da) and B (MW 18288.3 Da) variants differ in mass by 86 Da, which is due to the structural difference of two amino acids. (Ref. 2-44). The spectrum for transferrin shown in FIG. 25D and FIG. 25F is more complex. This is because the transferrin is an iron binding glycoprotein predominantly containing two biantennary fully sialylated N-glycans with a mass of 79,555 Da. (Ref 2-45). VSSI-MS analysis of transferrin yields the same deconvoluted mass (FIG. 25E) when using UniDec. (Ref 2-40). The mass spectrum of transferrin at 10 μM (FIG. 25F) is adducted, complicating deconvolution. However, with direct infusion at higher concentrations the predominant glycoform is observed (FIG. 25D and FIG. 25E).

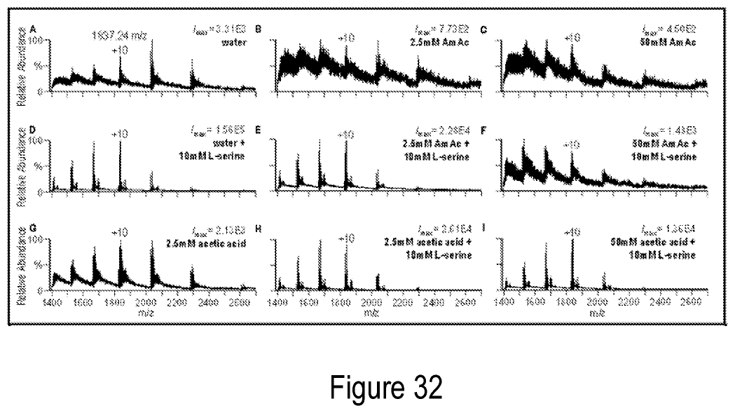

VSSI-MS sheath composition effect on ion suppression and adduction. CE-ESI-MS incorporating a sheath flow typically uses solutions differing from the separation electrolyte, like acid and organic solvent, to assist in ionization. (Ref 2-46-2-49). As CE-VSSI-MS is a new technique, the effect of the sheath flow composition on analyte response and peak adduction has not been studied previously. The effects of the sheath fluid composition were evaluated with β-lactoglobulin using direct infusion VSSI-MS. This was done to eliminate contributions of analyte desalting provided by the CE separation. The charge state distribution observed in the spectra obtained with direct infusion is comparable to the data obtained with CE. Analyte suppression is reduced in ESI by decreasing sheath fluid ionic strength when using low concentration analytes. (Ref 2-50). This effect is also observed in VSSI as shown in FIGS. 32A-C, where a 4-fold increase in the ion signal is observed when the sheath is changed from water (3.3E3, FIG. 32A) to 2.5 mM ammonium acetate (7.7E2, FIG. 32B). Approaches to improve the analyte signal by reducing metal ion adduction were also evaluated with β-lactoglobulin. Metal ion adduction is reportedly reduced in ESI by including amino acid additives, which directly interact with sodium ions to prevent adduct formation. (Ref. 2-51). This improvement is also observed with VSSI by comparing the signal obtained using a sheath fluid of 0, 2.5, or 50 mM ammonium acetate that includes 10 mM serine (FIGS. 32D-F), where a 50-fold improvement is observed in signal for water with and without serine (FIG. 32D vs FIG. 32A). In other examples, metal ion adduction is reduced in ESI-MS by acidifying the sheath. (Ref. 2-52). This improvement is also observed with VSSI by comparing the signal obtained using a sheath of 2.5 mM acetic acid (2.1E3, FIG. S2G) to 2.5 mM ammonium acetate (7.7E2, FIG. S2B), demonstrating a 3-fold increase in signal. As a result of these studies, when the background electrolyte is maintained at a neutral pH, the sheath resulting in the least adduction and analyte suppression is comprised of a low ionic strength solution and 10 mM L-serine. In some instances, the sheath fluid can include one or more amino acid additives. In some instances, the one or more amino acid additives can include at least one of L-serine, D-serine, or amino acid additives or L- or D-configuration.

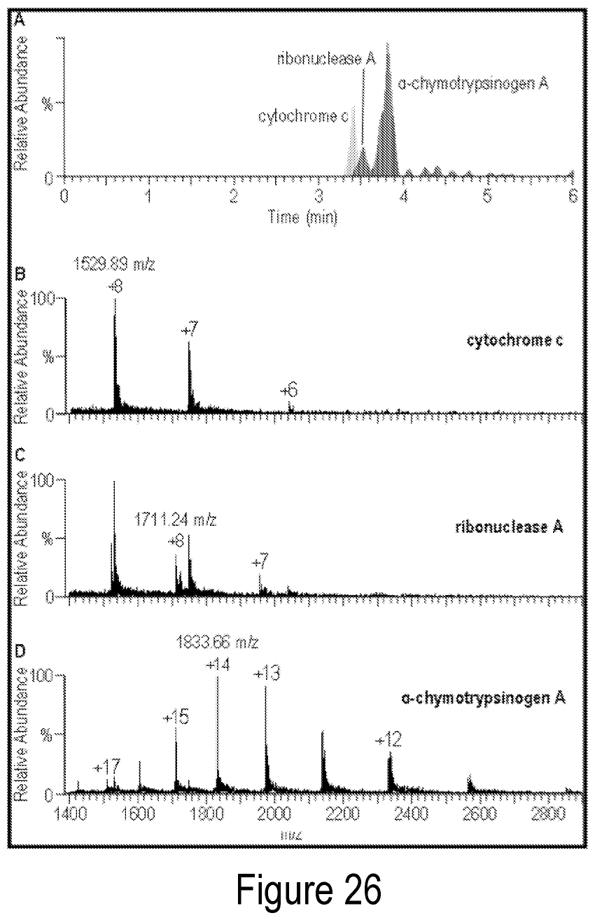

Cationic proteins require acidic conditions in an unmodified capillary. In contrast to anionic proteins, CE separations of cationic proteins in an unmodified capillary must be designed to address protein adsorption to the negatively charged silica surface. CE-ESI-MS typically utilizes an acidic background electrolyte to reduce this effect, and this strategy has been adapted to CE-VSSI-MS. This is demonstrated in FIG. 26A, which is an electrophoretic separation of cytochrome c (pI 10.0 to 10.6), ribonuclease A (pI 9.6), and α-chymotrypsinogen A (pI 8.97) in an unmodified capillary using an acidic background electrolyte and an aqueous sheath fluid. The proteins are partially (i.e., cytochrome c and ribonuclease A) or fully resolved (i.e., ribonuclease A and α-chymotrypsinogen A). The separation is complete within 4 minutes and the peak areas and migration times are reproducible with an RSD of 10% and 3%, respectively.

The CE-VSSI-MS separation of 2.5 μM cytochrome c, 10 μM ribonuclease A, and 10 μM α-chymotrypsinogen A (FIG. 26A) is comparable to CE-ESI-MS analyses in the literature reporting the detection of 2-16 μM cytochrome c, (Ref. 2-47, 2-48, 2-53-2-56) 4-73 μM ribonuclease A, (Ref 2-46, 2-47, 2-54-2-56) and 2-34 μM α-chymotrypsinogen A. (Ref 2-47, 2-55). The mass spectrum of each protein (FIG. 26B-FIG. 26D) shows a single charge envelope and minimal peak adduction. The dominant charge states formed with VSSI for cytochrome c (+8) and ribonuclease A (+8) are comparable to those reported using CE-ESI-MS. For example, the dominant charge states reported with CE-ESI-MS for cytochrome c ranged from +7 to +13, (Ref 2-46, 2-47, 2-53) and for ribonuclease A ranged from +8 to +9. (Ref. 2-46, 2-47, 2-54). For α-chymotrypsinogen A, the dominant charge state obtained with VSSI is +14; whereas, with ESI it is reportedly +12. (Ref. 2-46, 2-47). The shift to a higher dominant charge state observed for α-chymotrypsinogen A may be a result of protein refolding.

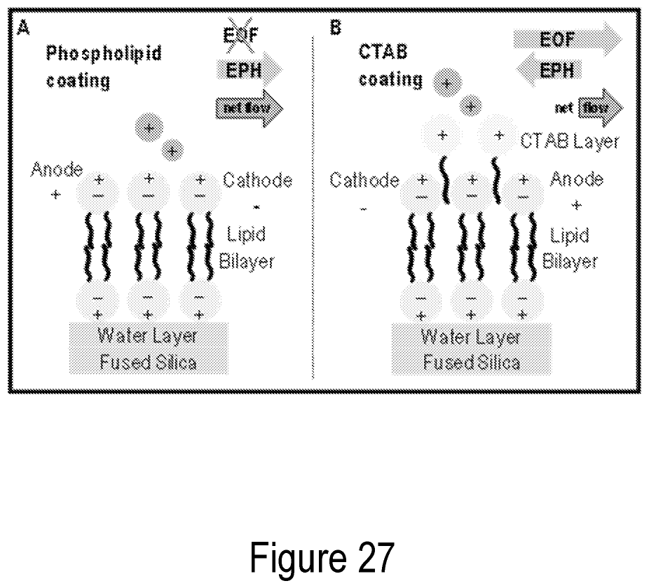

Semi-permanent coatings for CE. An alternative to using an acidic background electrolyte to separate cationic proteins is to passivate the capillary surface with a lipid coating to minimize surface adsorption. When the surface charge is masked, the separation can be conducted at physiological pH. The surface of the channel can be covalently modified with polymers that mitigate protein adsorption, (Ref. 2-57, 2-58) and these can be purchased or fabricated by the user. (Ref 2-46, 2-47). Semi-permanent capillary coatings are an alternative to covalently modified capillaries, (Ref. 2-59) which can be modified by simply flushing the capillary. Phospholipid coatings passivate the capillary surface by forming a zwitterionic lipid bilayer on top of the negatively charged silanol groups as depicted conceptually in FIG. 27. (Ref 2-38, 2-60, 2-61). The neutral lipid bilayer suppresses the electroosmotic flow significantly, (Ref 2-60) making the electrophoretic mobility the dominant transport mechanism of the protein separation. The lipid coating can be further modified with cetyltrimethylammonium bromide (CTAB) to be positively charged as depicted in FIG. 27B. (Ref 2-62). The incorporation of the positively charged CTAB induces an electroosmotic flow in the capillary, which under reverse polarity is directed toward the detection outlet. Both the lipid-based and CTAB-modified lipid coating have been effectively applied to cationic proteins at pH values ranging from 4 to 8 with CE-VSSI-MS analyses.

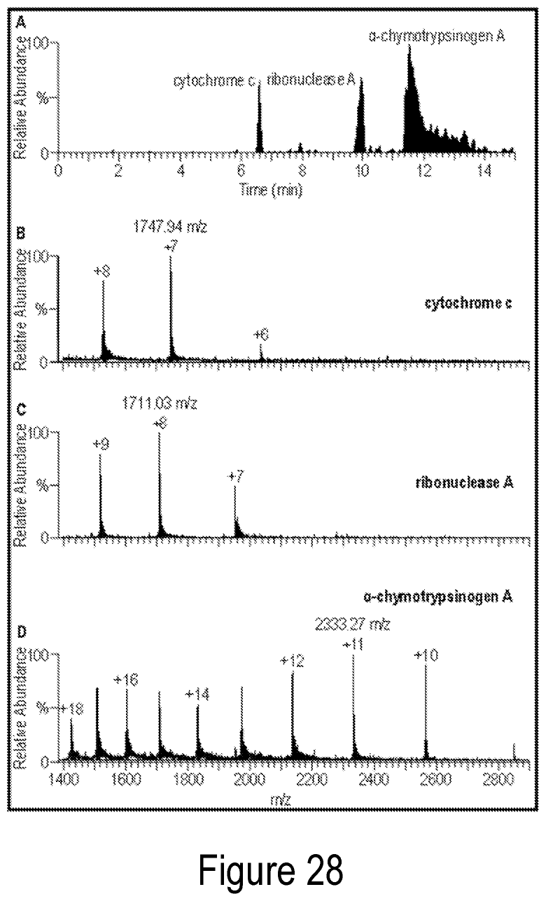

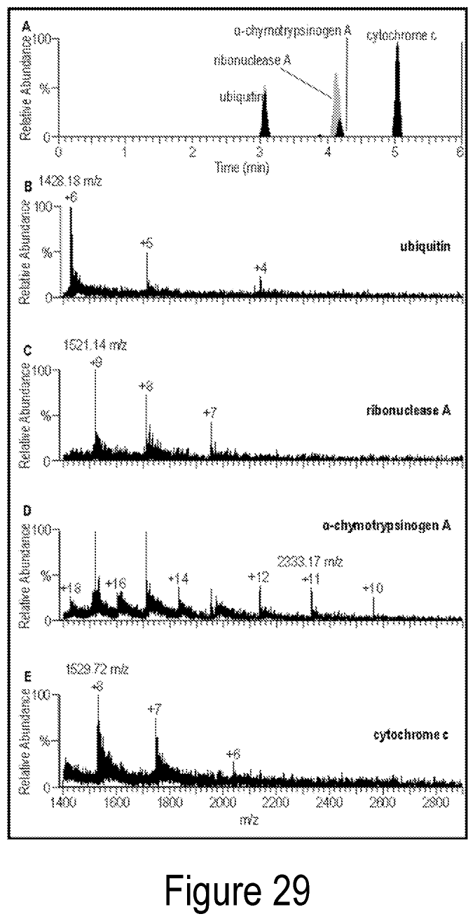

Semi-permanent coating for suppressed electroosmotic flow at neutral pH. A CE separation capillary with a semi-permanent lipid coating is achieved with a suppressed electroosmotic flow and a background electrolyte maintained at a pH of 7 for the cationic proteins: cytochrome c, ribonuclease A, and α-chymotrypsinogen A. In contrast to the separation achieved with the unmodified capillary and acidified background electrolyte (FIG. 26A), the proteins are fully resolved. The electropherogram shown in FIG. 28A is of 2.5 μM cytochrome c, 5 μM ribonuclease A, and 10 μM α-chymotrypsinogen A. These concentrations are similar to literature reports of CE-ESI-MS analyses. (Ref. 2-46-2-48, 2-53-2-56). A lower concentration of ribonuclease A could be detected because it no longer co-migrated with cytochrome c. The migration times obtained with the modified surface are longer because the electroosmotic flow is significantly lower; however the migration time reproducibility is similar. The spectra shown in FIG. 28B and FIG. 28C have a similar charge state distribution for cytochrome c and ribonuclease A. Adduction was minimized by the addition of 10 mM L-serine to a low ionic strength sheath fluid. The spectrum of α-chymotrypsinogen A shown in FIG. 28D has a bimodal charge state distribution, which is not observed when using an acidic background electrolyte. This indicates that the separation achieved at a neutral pH maintains some of the protein in a more native conformation.

This results demonstrate the successful implementation of a nanoflow sheath CE-VSSI-MS system providing more powerful information for protein analyses. For example, the CE-VSSI MS separations resolved lactoglobulin protein variants and shed light on the degree of glycosylation of anionic transferrin. Moreover, cationic protein separations can be performed using a neutral background electrolyte without excessive surface adsorption while still achieving a rapid separation. Additionally, the intensity of the protein signal is improved by modifying the composition of the low ionic strength sheath fluid to include a serine additive. This novel CE VSSI system enabled detection of proteins at concentrations that are similar to literature reports achieved with CE-ESI systems. In contrast to the ESI interfacing, the VSSI interfacing does not require acidic or organic buffers to enhance ionization. The nanoflow sheath is fully compatible with semi-permanent surface coatings operated under conditions of suppressed (i.e. lipid coating) or sustained (i.e. CTAB-lipid coating) electroosmotic flow, offering flexibility in the separation conditions used to resolve the protein samples. This study demonstrates a proof-of-principle of capillary electrophoresis-VSSI protein separations under physiological pH in the presence of a biocompatible surface coating. Future work will focus on the ability of this design to separate other protein systems, including larger protein complexes and to gain a better understanding about the ionization mechanisms of VSSI for proteins.

VE-VSSI-MS with VSSI Probe having a sheath fluid capillary.

In some example systems, the difference between the flow rates of the analyte liquid in the separation capillary and the sheath fluid in the sheath capillary can result in undesirable dilution of the analyte liquid. For example, if the flow rate of the sheath fluid is considerably greater than the flow rate of the analyte liquid, then the nebulized and ionized spray generated by the VSSI probe can include an undesirably diluted analyte liquid. In one approach, the flow rate of the sheath fluid can be reduced by incorporating the sheath capillary in the VSSI probe instead of over the separation capillary (as shown in FIG. 1). In particular, the VSSI probe includes a conduit that accommodates a sheath capillary that provides sheath fluid at the tip of the VSSI probe. Thus, the VSSI probe not only provides vibrational forces to the separation capillary, but also provides the sheath fluid. The combined analyte liquid discharged from the separation capillary and the sheath fluid discharged from the sheath capillary in the VSSI probe is nebulized by the tip of the VSSI probe into a spray, which is directed to the MS.

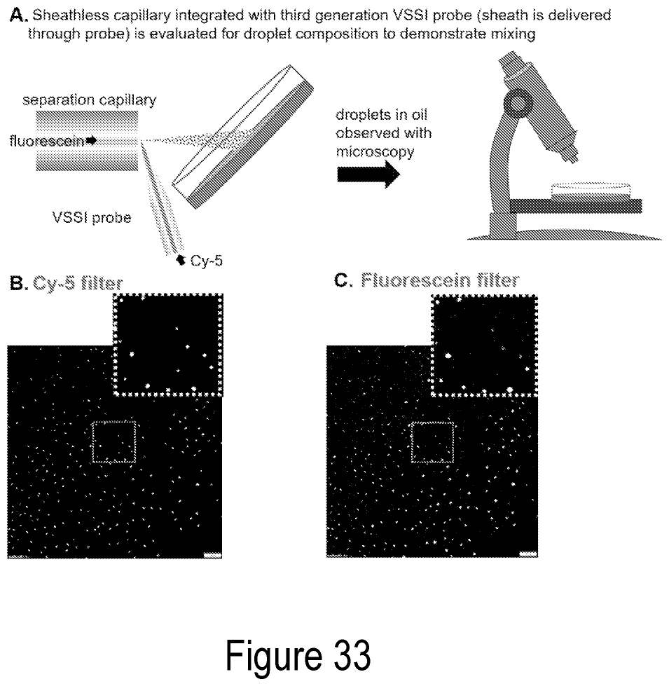

FIG. 33A shows a VSSI probe modified to accept sheath fluid delivery through the probe. The VSSI probe functions as the sheath capillary alleviating the need for a sheath capillary to cover the separation capillary in the manner shown in FIG. 1. To demonstrate effective mixing the spray formation of the combination of the analyte liquid and the sheath fluid, two different fluorophores, Cy-5 and fluorescein, are introduced in the separation capillary and the VSSI probe sheath capillary, respectively. For example, Cy-5 dye (λₑₓ=651 nm, λₑₘ=670 nm) is delivered through the VSSI probe sheath capillary at 900 nano-liters/min and fluorescein (λₑₓ=498 nm, λₑₘ=516 nm) is delivered through the separation capillary at 40 nano-liters/min. The VSSI probe is active, and the nebulized droplets are captured in a petri dish with mineral oil. The droplets are then observed with fluorescence microscopy using filters selective for each fluorophore. The captured images shown in FIGS. 33B and 33C show that the collected droplets include both dyes.

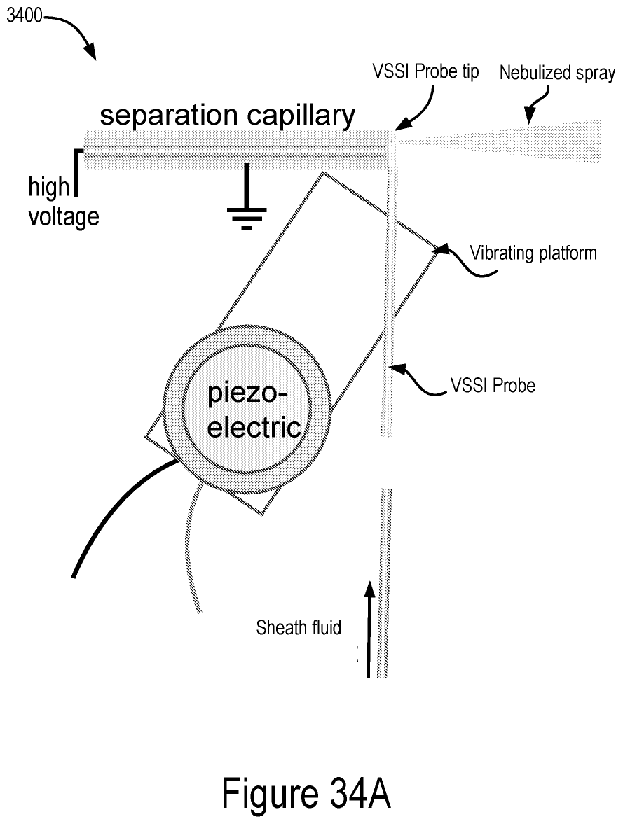

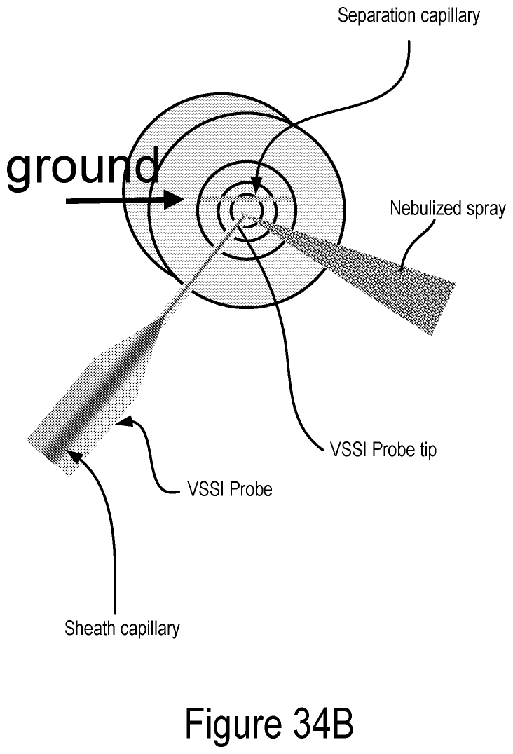

FIGS. 34A and 34B show top and front views of a second example analysis apparatus 3400. The second example analysis apparatus 3400 includes a separation capillary that provides the analyte liquid. The separation capillary shown in FIGS. 34A and 34B can be similar to the separation capillary 104 shown in FIG. 1. However, unlike the apparatus 100 shown in FIG. 1, where the separation capillary 104 was covered with the sheath capillary 112, the arrangement shown in FIG. 34B, the separation capillary is not covered with a sheath capillary. Instead, the sheath capillary is incorporated into the VSSI probe. The sheath fluid is delivered through the sheath capillary in the VSSI probe to the VSSI probe tip. The analyte liquid in the separation capillary is mixed with the sheath fluid in the sheath capillary and nebulized by the VSSI probe tip into a nebulized spray. The VSSI probe tip is vibrated by the vibrating platform that is coupled with the VSSI probe.

By incorporating the sheath capillary into the VSSI probe, the sheath capillary can be designed independently of the size of the sheath capillary. That is, without having to cover the separation capillary, which can be of different diameters thereby affecting the diameter of the sheath capillary, the sheath capillary incorporated in the VSSI probe can be sized independently of the size of the separation capillary. This helps reducing the cost of the apparatus.

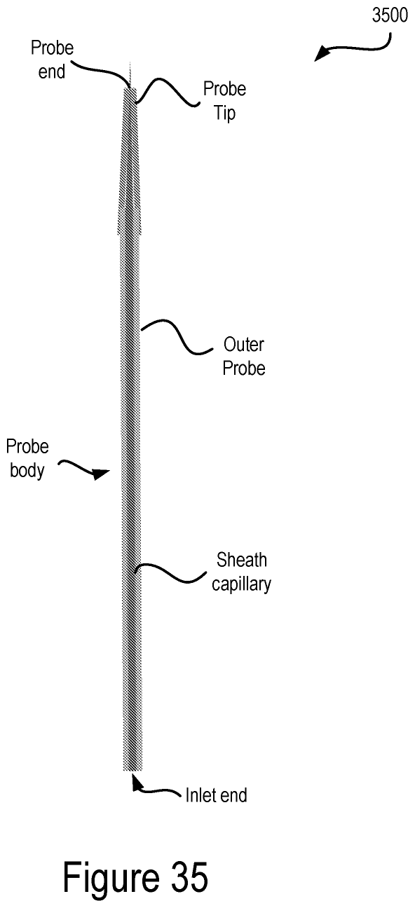

FIG. 35 shows an example VSSI probe with the sheath capillary incorporated therein. The VSSI probe 3500 can include a probe body and a probe tip. The probe tip, in some instances, can be reinforced as the probe tip is in contact with the separation capillary. The probe body and the probe tip can be, for example, a borosilicate pulled glass probe with an outer diameter ranging from 30 micrometers to 100 micrometers. However, these dimensions are only examples, and that actual dimensions will be a function of the implementation. The VSSI probe 3500 can be formed using materials other than glass, such as metals, thermoplastics, etc. A fused silica sheath capillary can be inserted inside of the VSSI probe 3500 and can be sealed, for example, with glue or epoxy. In some examples, the sheath capillary can be 50 cm long. Studies demonstrated that a 30 micrometer internal diameter sheath capillary operated from 20-30 psi sheath fluid supply resulted in a sheath fluid flow rates between 500 and 900 nano-liters/min. Studies also demonstrated that the above certain frequency and amplitude of vibration imparted to the VSSI probe 3500, the flow rate of the sheath fluid through the VSSI probe 3500 is primarily controlled by the applied pressure from the sheath fluid supply and the internal diameter of the sheath capillary. The frequency and amplitude of vibration, however, are specific to the physical characteristics of the VSSI probe used in a particular implementation and the vibrating platform. The VSSI probe 3500 can include a probe end and an inlet end. The probe end of the VSSI probe 3500 can be configured to vibrate by the probe body or the probe tip being coupled with a vibrating platform. The probe end can be positioned to make contact with the distal end 114 of the separation capillary 104. The inlet end can receive the sheath fluid and the sheath fluid can be carried from the inlet end to the probe end.

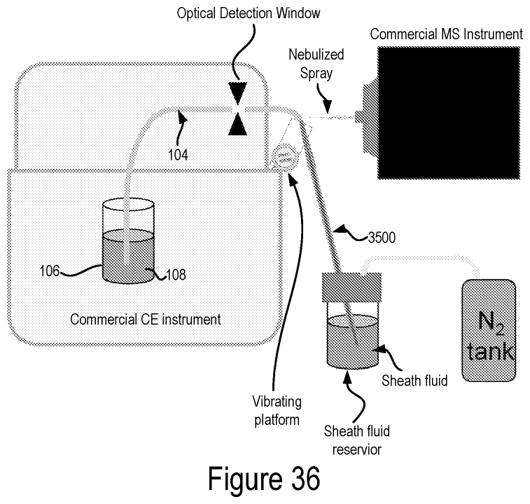

FIG. 36 shows a schematic of an analysis system 3600 that incorporates the second example analysis apparatus 3400 discussed above with commercial CE and MS apparatuses. The analysis system 3600 includes a commercial CE instrument, a commercial MS instrument, a vibrating platform, a VSSI probe 3500, a sheath fluid reservoir that stores sheath fluid under pressure. The commercial CE instrument includes the analyte reservoir 106 storing analyte liquid 108. One end of the separation capillary is positioned inside the analyte reservoir 106 while the other end is extended outside of the commercial CE instrument. The commercial CE instrument can also include an optical detection window that can be used for CE analysis. The VSSI probe 3500 is positioned such that the probe tip of the VSSI probe 3500 is in contact with the exposed end of the separation capillary. The VSSI probe 3500 is positioned into a sheath fluid reservoir that include sheath fluid. The sheath fluid reservoir can be maintained under pressure to maintain a desired flow rate of the sheath fluid through the VSSI probe 3500. As an example, the sheath fluid reservoir can be pressurized using nitrogen gas from a nitrogen gas tank. The vibrating probe tip of the VSSI probe 3500 can cause the mixture of the analyte liquid 108 from the separation capillary 104 and the sheath fluid from the sheath capillary in the VSSI probe 3500 to nebulize and form a nebulized spray that is directed towards the inlet of the commercial MS instrument for MS analysis.

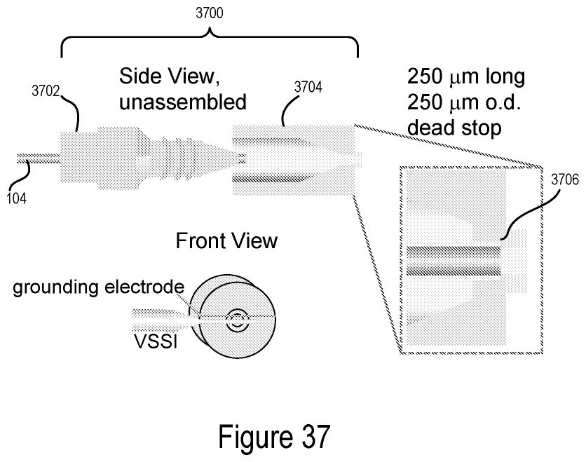

FIG. 37 shows side and front views of a first example connector 3700 that can be used in conjunction with a CE-VSSI-MS system. The first example connector 3700 can include a conduit which accommodates the separation capillary 104. The first example connector 3700 can include a nut portion 3702 and a port portion 3704. The nut portion 3702 can screw into the port portion 3704 the port portion 3704 can include a dead stop formed on the inner surface of the port portion 3704. The port portion 3704 and the nut portion 3702 can include a conduits that are aligned, such that when the nut portion 3702 and the port portion 3704 are coupled, the separation capillary 104 can pass through the conduit in the nut portion 3702 to the conduit in the port portion 3704. A grounding electrode can be positioned at the outlet of the first example connector 3700. In addition, a VSSI acoustic probe having a sheath capillary can be positioned at the outlet of the first example connector 3700.

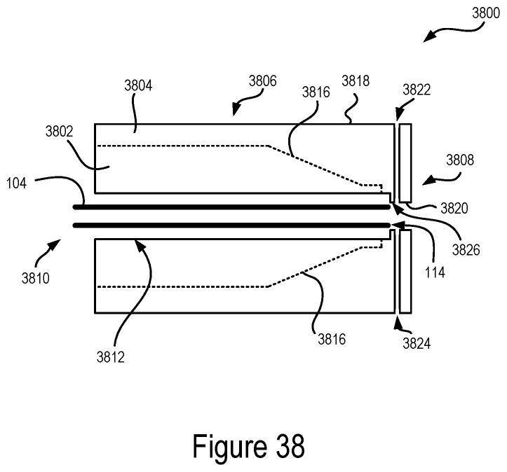

FIG. 38 shows a cross-sectional view of a second example connector 3800 that can be used in conjunction with a CE-VSSI-MS system. In one example, the second example connector 3800 can be similar to the first example connector 3700 discussed above in relation to FIG. 37, in that the second example connector 3800 can include a nut portion 3802 and a port portion 3804 (separation between the nut portion and the port portion is indicated by broken lines 3816). However, in some instances, the second example connector 3800 may not include separable portions, and instead include an integrated body. The second example connector 3800 can include a connector body 3806 having a first end 3808 and a second end 3810. The second example connector 3800 can further include a conduit 3812 that extends between the first end 3808 and the second end 3810 of the connector body 3806. The conduit 3812 can be configured to removably receive the separation capillary 104. The conduit 3812 can have a diameter that is greater than the outer diameter of the separation capillary 104.

A ground terminal slot 3822 can be positioned at the first end 3808 of the connector body 3806. The ground terminal slot 3822 can extend between an outside surface 3818 of the connector body 3806 and an inner surface 3820 of the conduit 3812. The ground terminal slot 3822 can be configured to removably receive a ground terminal that is part of the CE. The internal diameter or width of the ground terminal slot 3822 can be greater than the corresponding diameter or width of the ground terminal. In some instances, the inner wall of the ground terminal slot 3822 can include an insulating material. The ground terminal can be positioned such that it makes contact with the analyte liquid 108 exiting the separation capillary 104.

The second example connector 3800 can also include an acoustic probe slot 3824 positioned at the first end 3808 of the connector body 3806. The acoustic probe slot 3824 can extend between the outside surface 3818 of the connector body 3806 and an inner surface 3820 of the conduit 3812. The acoustic probe slot 3824 can be configured to removably receive an acoustic probe that has a sheath capillary such as, for example, the VSSI probe 3500 discussed above in relation to FIG. 35. The inner diameter or width of the acoustic probe slot 3824 can be greater than the outer diameter or width of the acoustic probe. In some instances, the outside surface 3818 of the connector body 3806 can include additional attachments to secure the acoustic probe into the acoustic probe slot 3824. The acoustic probe can be positioned such that the tip of the acoustic probe makes contact with the distal end 114 of the separation capillary 104.

In instances where the connector body 3806 includes the nut portion 3802 and the port portion 3804, the ground terminal slot 3822 and the acoustic probe slot 3824 can be formed in the port portion 3804. In some instances, the ground terminal slot 3822 and the acoustic probe slot 3824 can traverse through both the port portion 3804 and the nut portion 3802 extending between the outside surface 3818 of the connector body 3806 and the inner surface of the conduit 3812. In some instances, the ground terminal slot 3822 or the 3824 or both can be positioned such that the dead stop 3826 is positioned between the slot and the first end 3808 of the connector body 3806.

The connector body 3806 can also include a dead stop 3826 that is formed on an inner surface of the conduit 3812. The dead stop 3826 can have a diameter that is less than the diameter of the separation capillary 104 and can stop the separation capillary 104 from extending out of the conduit 3812 at the first end 3808. In instances where the connector body 3806 includes the nut portion 3802 and the port portion 3804, the conduit 3812 can have a first portion that is formed in the nut portion 3802 and a second portion that is formed in the port portion 3804. The dead stop 3826 can then be formed in the second portion of the conduit 3812 (i.e., in the port portion 3804). In some instances, the dead stop can instead be formed in the nut portion 3802.

The connector body 3806 can be formed of any rigid material such as, for example, metal, thermoplastics or a combination thereof. The connector body 3806 can be built using casting methods, milling methods, CNC methods, 3D printing methods, or other methods know in the art for manufacturing similar types of devices.

Aspects: the following provides details of various aspects in relation to the disclosure.

Aspect 1: This aspect includes an apparatus, including: a separation capillary having an injection end and a distal end, the injection end configured to receive analyte liquid and the distal end configured to expel the analyte liquid; a sheath capillary covering the distal end of the separation capillary, the sheath capillary having a diameter that is greater than an outer diameter of the separation capillary at the distal end, the sheath capillary having a first end and a second end, the distal end of the separation capillary positioned between the first end and the second end of the sheath capillary, the sheath capillary carrying a fluid between the second end and the first end; an acoustic probe configured to vibrate positioned in contact with the at least one of the distal end of the separation capillary or the first end of the sheath capillary; and a ground terminal positioned at the first end of the sheath capillary.

Aspect 2: An aspect in combination with any one of the aspects 1, 3-20, wherein a flow rate of the fluid in the sheath capillary is less than one microliter per minute.

Aspect 3: An aspect in combination with any one of the aspects 1-2, 4-20, wherein a longitudinal axis of the acoustic probe is positioned between 80 degrees to 125 degrees in relation to a longitudinal axis of at least one of the separation capillary or the first end of the sheath capillary.

Aspect 4: An aspect in combination with any one of the aspects 1-3, 5-20, wherein the separation capillary has a length, measured between the injection end and the distal end, between 5 cm and 2 m.

Aspect 5: An aspect in combination with any one of the aspects 1-4, 6-20, wherein the separation capillary has a total volume of no more than 8 micro-liters.

Aspect 6: An aspect in combination with any one of the aspects 1-5, 7-20, wherein an inner diameter of the separation capillary is between 15 micrometers and 35 micrometers.

Aspect 7: An aspect in combination with any one of the aspects 1-6, 8-20, wherein a distance between the distal end of the separation capillary and the ground terminal is less than 2 millimeters.

Aspect 8: An aspect in combination with any one of the aspects 1-7, 9-20, wherein a voltage difference is maintained between the injection end of the separation capillary and the ground terminal.

Aspect 9: An aspect in combination with any one of the aspects 1-8, 10-20, wherein a flow rate of the analyte liquid in the separation capillary is between 0 nano-liters and 70 nano-liters.

Aspect 10: An aspect in combination with any one of the aspects 1-9, 11-20, wherein at least a portion of the inner surface of the separation capillary is coated with lipids.

Aspect 11: An aspect in combination with any one of the aspects 1-10, 12-20, wherein electroosmotic flow within the separation capillary is suppressed.

Aspect 12: An aspect in combination with any one of the aspects 1-11, 13-20, wherein the analyte liquid includes small or large molecules that are positively charged, negatively charged, or neutral charged.

Aspect 13: An aspect in combination with any one of the aspects 1-12, 14-20, wherein the analyte liquid includes cationic proteins and acidic background electrolytes.

Aspect 14: An aspect in combination with any one of the aspects 1-13, 15-20, wherein the analyte liquid includes cationic proteins, and wherein at least a portion of the inner surface of the separation capillary has at least one of a net neutral lipid coating or a hybrid cationic lipid coating.

Aspect 15: An aspect in combination with any one of the aspects 1-14, 16-20, wherein the at least one of a net neutral lipid coating or a hybrid cationic lipid coating is semi-permanent.

Aspect 16: An aspect in combination with any one of the aspects 1-15, 17-20, wherein the at least one of a net neutral lipid coating or a hybrid cationic lipid coating is positively charged.

Aspect 17: An aspect in combination with any one of the aspects 1-16, 18-20, wherein the analyte liquid includes anionic or neutral proteins and an electrolyte buffer at a pH of above 7.

Aspect 18: An aspect in combination with any one of the aspects 1-17, 19-20, wherein the fluid in the sheath capillary is an electrolyte with neutral pH.

Aspect 19: An aspect in combination with any one of the aspects 1-18, and 20, wherein the fluid in the sheath capillary includes one or more amino acid additives.

Aspect 20: An aspect in combination with any one of the aspects 1-19, wherein the one or more amino acid additives include at least one of L-serine, D-serine, or amino acid additives or L- or D-configuration.

Aspect 21: This aspect includes an apparatus, including: a separation capillary having an injection end and a distal end, the injection end configured to receive analyte liquid and the distal end configured to expel the analyte liquid; an acoustic probe capillary having a probe end and an inlet end, the probe end of the acoustic probe capillary configured to vibrate and positioned in contact with the distal end of the separation capillary, the acoustic probe capillary carrying a fluid from the inlet end to the probe end; and a ground terminal positioned at the distal end of the separation capillary.

Aspect 22: An aspect in combination with any one of the aspects 21 and 23-43, further including: a connector having a conduit for removably receiving the separation capillary, the connector including a slot to accommodate the acoustic probe capillary, wherein the conduit and the slot are positioned such that the probe end of the acoustic probe capillary makes contact with the distal end of the separation capillary.

Aspect 23: An aspect in combination with any one of the aspects 21-22, 24-43, wherein the connector further includes a housing to house a ground terminal, wherein the housing and the conduit are positioned to such that the ground terminal makes contact with the distal end of the separation capillary.

Aspect 24: An aspect in combination with any one of the aspects 21-23, 25-43, wherein a portion of the acoustic probe capillary is coupled with a vibrating structure.

Aspect 25: An aspect in combination with any one of the aspects 21-24, 26-43, wherein the vibrating structure includes a piezoelectric transducer.

Aspect 26: An aspect in combination with any one of the aspects 21-25, 27-43, wherein a flow rate of the fluid in the acoustic probe capillary is less than one microliter per minute.

Aspect 27: An aspect in combination with any one of the aspects 21-26, 28-43, wherein the separation capillary has a length, measured between the injection end and the distal end, between 5 cm and 2 m.

Aspect 28: An aspect in combination with any one of the aspects 21-27, 29-43, wherein the separation capillary has a total volume of no more than 8 micro-liters.

Aspect 29: An aspect in combination with any one of the aspects 21-28, 30-43, wherein a voltage difference is maintained between the injection end of the separation capillary and the ground terminal.

Aspect 30: An aspect in combination with any one of the aspects 21-29, 31-43, wherein an inner diameter of the separation capillary is between 15 micrometers to 35 micrometers.

Aspect 31: An aspect in combination with any one of the aspects 21-30, 32-43, wherein a distance between the distal end of the separation capillary and the ground terminal is less than 2 millimeters.

Aspect 32: An aspect in combination with any one of the aspects 21-31 33-43, wherein a flow rate of the analyte liquid in the separation capillary is between 0 nano-liters and 70 nano-liters.

Aspect 33: An aspect in combination with any one of the aspects 21-32, 34-43, wherein at least a portion of the inner surface of the separation capillary is coated with lipids.

Aspect 34: An aspect in combination with any one of the aspects 21-33, 35-43, wherein electroosmotic flow within the separation capillary is suppressed.

Aspect 35: An aspect in combination with any one of the aspects 21-34, 36-43, wherein the analyte liquid includes small or large molecules that are positively charged, negatively charged, or neutral charged.

Aspect 36: An aspect in combination with any one of the aspects 21-35, 37-43, wherein the analyte liquid includes cationic proteins and acidic background electrolytes.

Aspect 37: An aspect in combination with any one of the aspects 21-36, 38-43, wherein the analyte liquid includes cationic proteins, and wherein at least a portion of the inner surface of the separation capillary has at least one of a net neutral lipid coating or a hybrid cationic lipid coating.

Aspect 38: An aspect in combination with any one of the aspects 21-37, 39-43, wherein the at least one of a net neutral lipid coating or a hybrid cationic lipid coating is semi-permanent.

Aspect 39: An aspect in combination with any one of the aspects 21-38, 40-43, wherein the at least one of a net neutral lipid coating or a hybrid cationic lipid coating is positively charged.

Aspect 40: An aspect in combination with any one of the aspects 21-39, 41-43, wherein the analyte liquid includes anionic or neutral proteins and an electrolyte buffer at a pH of above 7.

Aspect 41: An aspect in combination with any one of the aspects 21-40, 42-43, wherein the fluid in the acoustic probe capillary is an electrolyte with neutral pH.

Aspect 42: An aspect in combination with any one of the aspects 21-41 and 43, wherein the fluid in the acoustic probe capillary includes one or more amino acid additives.

Aspect 43: An aspect in combination with any one of the aspects 21-42, wherein the one or more amino acid additives include at least one of L-serine, D-serine, or amino acid additives or L- or D-configuration.

Aspect 44: This aspect includes a connector, including: a connector body having a first end and a second end; a conduit extending between the first end and the second end of the connector body, the conduit configured to removably receive a separation capillary, wherein a portion of the conduit at the first end of the connector body accommodates a distal end of the separation capillary; and an acoustic probe slot positioned at the first end of the connector body, the acoustic probe slot extends between an outside surface of the connector body and the inner surface of the conduit, the acoustic probe slot configured to removably receive an acoustic probe having a sheath capillary.

Aspect 45: An aspect in combination with any one of the aspects 45-51, further including: a ground terminal slot positioned at the first end of the connector body, the ground terminal slot extends between an outside surface of the connector body and an inner surface of the conduit, ground terminal slot configured to removably receive a ground terminal.

Aspect 46: An aspect in combination with any one of the aspects 44-45, 47-51, further including: A dead stop positioned in the conduit at the first end of the connector body, the dead stop configured to have a diameter that is less than a diameter of the separation capillary such that the separation capillary is prevented from being pushed out of the conduit at the first end.

Aspect 47: An aspect in combination with any one of the aspects 44-46, 48-51, wherein the connector body is formed of at least one of metal or thermoplastic.

Aspect 48: An aspect in combination with any one of the aspects 44-47, 49-51, wherein the connector body includes a dead stop formed on an inner surface of the conduit, wherein the dead stop has a diameter that is less than the diameter of the separation capillary.

Aspect 49: An aspect in combination with any one of the aspects 44-48, 49-51, wherein the connector body includes: a nut portion and a port portion, wherein the nut portion screws into the port portion, wherein a portion of the conduit is formed in the nut portion and a second portion of the conduit is formed in the port portion, and a dead stop formed on the inner surface of the second portion of the conduit in the port portion, wherein the dead stop has a diameter that is less than the diameter of the separation capillary.

Aspect 50: An aspect in combination with any one of the aspects 44-49 and 51, further including; a ground terminal slot positioned at the first end of the connector body, the ground terminal slot extends between an outside surface of the connector body and an inner surface of the conduit, ground terminal slot configured to removably receive a ground terminal, wherein the ground terminal slot is formed in the port portion.

Aspect 51: An aspect in combination with any one of the aspects 44-50, wherein the acoustic probe slot is formed in the port portion.

References: All cited references, patent or literature, are incorporated by reference in their entirety. The examples disclosed herein are illustrative and not limiting in nature. Details disclosed with respect to the methods described herein included in one example or embodiment may be applied to other examples and embodiments. Any aspect of the present disclosure that has been described herein may be disclaimed, i.e., exclude from the claimed subject matter whether by proviso or otherwise.
(1-1) Beccaria, M.; Cabooter, D. Analyst 2020, 145, 1129-1157.
(1-2) Kristoff, C. J.; Bwanali, L.; Veltri, L. M.; Gautam, G. P.; Rutto, P. K.; Newton, E. O.; Holland, L. A. Anal. Chem. 2020, 92, 49-66.
(1-3) Huang, L.; Wang, Z.; Cupp-Sutton, K. A.; Smith, K.; Wu, S. Anal. Chem. 2020, 92, 640-646.581
(1-4) Kawai, T.; Ota, N.; Okada, K.; Imasato, A.; Owa, Y.; Morita, M.; Tada, M.; Tanaka, Y. Anal. Chem. 2019, 91, 10564-10572.
(1-5) Saoi, M.; Percival, M.; Nemr, C.; Li, A.; Gibala, M.; Britz-McKibbin, P. Anal. Chem. 2019, 91, 4709-4718.
(1-6) Sasaki, K.; Sagawa, H.; Suzuki, M.; Yamamoto, H.; Tomita, M.; Soga, T.; Ohashi, Y. Anal. Chem. 2019, 91, 1295-1301.
(1-7) Zhang, W.; Guled, F.; Hankemeier, T.; Ramautar, R. J. Chromatogr. B 2019, 1105, 10-14.
(1-8) Choi, S. B.; Polter, A. M.; Nemes, P. Anal. Chem. 2022, 94, 1637-1644.
(1-9) Lombard-Banek, C.; Moody, S. A.; Manzini, M. C.; Nemes, P. Anal. Chem. 2019, 91, 4797-4805.
(1-10) Szigeti, M.; Guttman, A. Molecular & Cellular Proteomics 2019, 18, 2524-2531.
(1-11) Salim, H.; Pero-Gascon, R.; Giménez, E.; Benavente, F. Anal. Chem. 2022, 94, 6948.
(1-12) Gill, B.; Jobst, K.; Britz-McKibbin, P. Anal. Chem. 2020, 92, 599 13558-13564.
(1-13) Pero-Gascon, R.; Benavente, F.; Minic, Z.; Berezovski, M. V.; Sanz-Nebot, V. Anal. Chem. 2020, 92, 1525-1533.
(1-14) Azab, S.; Ly, R.; Britz-McKibbin, P. Anal. Chem. 2019, 91, 2329-2336.
(1-15) Gstöttner, C.; Hook, M.; Christopeit, T.; Knaupp, A.; Schlothauer, T.; Reusch, D.; Haberger, M.; Wuhrer, M.; Domínguez-Vega, E. Anal. Chem. 2021, 93, 15133-15141.
(1-16) Han, M.; Wang, Y.; Cook, K.; Bala, N.; Soto, M.; Rock, D. A.; Pearson, J. T.; Rock, B. M. Anal. Chem. 2021, 93, 5562-5569.
(1-17) Řemínek, R.; Foret, F. Electrophoresis 2021, 42, 19-37.
(1-18) Stolz, A.; Jooß, K.; Höcker, O.; Römer, J.; Schlecht, J.; Neüß, C. Electrophoresis 2019, 40, 79-112.
(1-19) Höcker, O.; Montealegre, C.; Neusüß, C. Anal. Bioanal. Chem. 2018, 410, 5265-5275.
(1-20) Schlecht, J.; Stolz, A.; Hofmann, A.; Gerstung, L.; Neusüß, C. Anal. Chem. 2021, 93, 14593-14598.
(1-21) Peuchen, E. H.; Zhu, G.; Sun, L.; Dovichi, N. J. Anal. Bioanal. Chem. 2017, 409, 1789-1795.
(1-22) Sun, L.; Zhu, G.; Zhang, Z.; Mou, S.; Dovichi, N. J. J. Proteome Res. 2015, 14, 2312-2321.
(1-23) Li, X.; Attanayake, K.; Valentine, S. J.; Li, P. Rapid Commun. Mass Spectrom. 2021, 35, No. e8232.
(1-24) Ranganathan, N.; Lozier, A. M.; Rawson, M. C.; Johnson, M. B.; Li, P. Rapid Commun. Mass Spectrom. 2020, 34, No. e8902.
(1-25) Ranganathan, N.; Li, C.; Suder, T.; Karanji, A. K.; Li, X.; He, Z.; Valentine, S. J.; Li, P. J. Am. Soc. Mass Spectrom. 2019, 30, 824-31.
(1-26) Li, C.; Attanayake, K.; Valentine, S. J.; Li, P. Anal. Chem. 2020, 92, 2492-2502.
(1-27) Jayasundara, K. U.; Li, C.; DeBastiani, A.; Sharif, D.; Li, P.; Valentine, S. J. J. Am. Soc. Mass Spectrom. 2021, 32, 84-94.
(1-28) Majuta, S. N.; DeBastiani, A.; Li, P.; Valentine, S. J. J. Am. Soc. Mass Spectrom. 2021, 32, 473-485.
(1-29) DeBastiani, A.; Majuta, S. N.; Sharif, D.; Attanayake, K.; Li, C.; Li, P.; Valentine, S. J. ACS Omega 2021, 6, 18370-18382.
(1-30) Kristoff, C. J.; Li, C.; Li, P.; Holland, L. A. Anal. Chem. 2020, 92, 3006-3013.
(1-31) Bonvin, G.; Veuthey, J.-L.; Rudaz, S.; Schappler, J. Electrophoresis 2012, 33, 552-562.
(1-32) González-Ruiz, V.; Codesido, S.; Far, J.; Rudaz, S.; Schappler, J. Electrophoresis 2016, 37, 936-946.
(1-33) Crihfield, C. L.; Kristoff, C. J.; Veltri, L. M.; Penny, W. M.; Holland, L. A. J. Chromatogr. A 2019, 1607, 460397.
(1-34) Archer-Hartmann, S. A.; Sargent, L. M.; Lowry, D. T.; Holland, L. A. Anal. Chem. 2011, 83, 2740-7.
(1-35) Luo, R.; Archer-Hartmann, S. A.; Holland, L. A. Anal. Chem. 2010, 82, 1228-33.
(1-36) Landers, J. P. Handbook of Capillary and Microchip Electrophoresis and Associated Microtechniques, second ed.; Taylor & Francis: Boca Raton, 1997; Appendix 1: Calculations of Practical Use, p 869.
(1-37) Soga, T.; Heiger, D. N. Anal. Chem. 2000, 72, 1236-1241.
(1-38) DiBattista, A.; McIntosh, N.; Lamoureux, M.; Al-Dirbashi, O. Y.; Chakraborty, P.; Britz-McKibbin, P. Anal. Chem. 2017, 89, 8112-8121.
(1-39) Cieslarova, Z.; Lopes, F. S.; do Lago, C. L.; França, M. C.; Colnaghi Simionato, A. V. Talanta 2017, 170, 63-68.
(1-40) Maxwell, E. J.; Zhong, X.; Zhang, H.; van Zeijl, N.; Chen, D. D. Y. Electrophoresis 2010, 31, 1130-1137.
(1-41) Schiavone, N. M.; Sarver, S. A.; Sun, L.; Wojcik, R.; Dovichi, N. J. J. Chromatogr. B 2015, 991, 53-58.
(1-42) Cunliffe, J. M.; Baryla, N. E.; Lucy, C. A. Anal. Chem. 2002, 74, 776-783.
(1-43) White, C. M.; Luo, R.; Archer-Hartmann, S. A.; Holland, L. A. Electrophoresis 2007, 28, 3049-55.
(1-44) Wells, S. S.; De La Toba, E.; Harrison, C. R. Electrophoresis 2016, 37, 1303-9.
(1-45) Draper, W. M.; Xu, D.; Perera, S. K. Anal. Chem. 2009, 81, 4153-4160.
(1-46) Hua, Y.; Jenke, D. J. Chromatogr. Sci. 2012, 50, 213-227.
(1-47) Zhou, S.; Cook, K. D. J. Am. Soc. Mass Spectrom. 2000, 11, 961-966.
(1-48) Tseng, M.-C.; Chen, Y.-R.; Her, G.-R. Electrophoresis 2004, 25, 2084-2089.
(1-49) Bonvin, G.; Schappler, J.; Rudaz, S. J. Chromatogr. A 2014, 1323, 163-173.
(2-1) Kaur, H.; Beckman, J.; Zhang, Y.; Li, Z. J.; Szigeti, M.; Guttman, A. Capillary Electrophoresis and the Biopharmaceutical Industry: Therapeutic Protein Analysis and Characterization. TrAC, Trends Anal. Chem. 2021, 144, 116407. DOI: https://doi.org/10.1016/j.trac.2021.116407.
(2-2) Tamizi, E.; Jouyban, A. The Potential of the Capillary Electrophoresis Techniques for Quality Control of Biopharmaceuticals—a Review. Electrophoresis 2015, 36 (6), 831-858. DOI: https://doi.org/10.1002/elps.201400343.
(2-3) Sharmeen, S.; Kyei, I.; Hatch, A.; Hage, D. S. Analysis of Drug Interactions with Serum Proteins and Related Binding Agents by Affinity Capillary Electrophoresis: A Review. Electrophoresis 2022, 43 (23-24), 2302-2323. DOI: https://doi.org/10.1002/elps.202200191.
(2-4) Zhang, W.; Xiang, Y.; Xu, W. Probing Protein Higher-Order Structures by Native Capillary Electrophoresis-Mass Spectrometry. TrAC, Trends Anal. Chem. 2022, 157, 116739. DOI: https://doi.org/10.1016/j.trac.2022.116739.
(2-5) Yu, F.; Zhao, Q.; Zhang, D.; Yuan, Z.; Wang, H. Affinity Interactions by Capillary Electrophoresis: Binding, Separation, and Detection. Anal. Chem. 2019, 91(1), 372-387. DOI: 10.1021/acs.analchem.8b04741.
(2-6) Kristoff, C. J.; Bwanali, L.; Veltri, L. M.; Gautam, G. P.; Rutto, P. K.; Newton, E. O.; Holland, L. A. Challenging Bioanalyses with Capillary Electrophoresis Anal. Chem. 2020, 92 (1), 49-66.
(2-7) Landers, J. P. Handbook of Capillary and Microchip Electrophoresis and Associated Microtechniques, Page 15; Taylor & Francis, 1997.
(2-8) Karch, K. R.; Snyder, D. T.; Harvey, S. R.; Wysocki, V. H. Native Mass Spectrometry: Recent Progress and Remaining Challenges. Annual Review of Biophysics 2022, 51 (1), 157-179. DOI: 10.1146/annurev-biophys-092721-085421.
(2-9) Liu, X. R.; Zhang, M. M.; Gross, M. L. Mass Spectrometry-Based Protein Footprinting for Higher-Order Structure Analysis: Fundamentals and Applications. Chem. Rev. 2020, 120 (10), 4355-4454. DOI: 10.1021/acs.chemrev.9b00815.
(2-10) Smith, R. D.; Barinaga, C. J.; Udseth, H. R. Improved Electrospray Ionization Interface for Capillary Zone Electrophoresis-Mass Spectrometry. Anal. Chem. 1988, 60 (18), 1948-1952. DOI: 10.1021/ac00169a022.
(2-11) Smith, R. D.; Olivares, J. A.; Nguyen, N. T.; Udseth, H. R. Capillary Zone Electrophoresis-Mass Spectrometry Using an Electrospray Ionization Interface. Anal. Chem. 1988, 60 (5), 436-441. DOI: 10.1021/ac00156a013.
(2-12) Höcker, O.; Montealegre, C.; Neusüß, C. Characterization of a Nanoflow Sheath Liquid Interface and Comparison to a Sheath Liquid and a Sheathless Porous-Tip Interface for Ce-Esi-Ms in Positive and Negative Ionization. Anal. Bioanal. Chem. 2018, 410 (21), 5265-5275, Article. DOI: 10.1007/s00216-018-1179-3.
(2-13) Stolz, A.; Jooß, K.; Höcker, O.; Römer, J.; Schlecht, J.; Neusüß, C. Recent Advances in Capillary Electrophoresis-Mass Spectrometry: Instrumentation, Methodology and Applications. Electrophoresis 2019, 40 (1), 79-112. DOI: doi:10.1002/elps.201800331.
(2-14) Moini, M. Simplifying Ce-Ms Operation. 2. Interfacing Low-Flow Separation Techniques to Mass Spectrometry Using a Porous Tip. Anal. Chem. 2007, 79 (11), 4241-4246. DOI: 10.1021/ac0704560.
(2-15) Nguyen, T. T. T. N.; Petersen, N. J.; Rand, K. D. A Simple Sheathless Ce-Ms Interface with a Sub-Micrometer Electrical Contact Fracture for Sensitive Analysis of Peptide and Protein Samples. Anal. Chim. Acta 2016, 936, 157-167. DOI: https://doi.org/10.1016/j.aca.2016.07.002.
(2-16) Johnson, R. T.; To, N. H.; Stobaugh, J. F.; Lunte, C. E. The Development of a Sheathless Interface for Capillary Electrophoresis Electrospray Ionization Mass Spectrometry Using a Cellulose Acetate Cast Capillary. Chromatographia 2017, 80 (7), 1061-1067. DOI: 10.1007/s10337-017-3326-y.
(2-17) Huang, L.; Wang, Z.; Cupp-Sutton, K. A.; Smith, K.; Wu, S. Spray-Capillary: An Electrospray-Assisted Device for Quantitative Ultralow-Volume Sample Handling. Anal. Chem. 2020, 92 (1), 640-646. DOI: 10.1021/acs.analchem.9b04131.
(2-18) Peuchen, E. H.; Zhu, G.; Sun, L.; Dovichi, N. J. Evaluation of a Commercial Electro-Kinetically Pumped Sheath-Flow Nanospray Interface Coupled to an Automated Capillary Zone Electrophoresis System. Anal. Bioanal. Chem. 2017, 409 (7), 1789-1795. DOI: 10.1007/s00216-016-0122-8.
(2-19) Štěpánová, S.; Kašička, V. Recent Applications of Capillary Electromigration Methods to Separation and Analysis of Proteins. Anal. Chim. Acta 2016, 933, 23-42. DOI: https://doi.org/10.1016/j.aca.2016.06.006.
(2-20) Štěpánová, S.; Kašička, V. Applications of Capillary Electromigration Methods for Separation and Analysis of Proteins (2017-Mid 2021)—a Review. Anal. Chim. Acta 2022, 1209, 339447. DOI: https://doi.org/10.1016/j.aca.2022.339447.
(2-21) Haselberg, R.; De Vijlder, T.; Heukers, R.; Smit, M. J.; Romijn, E. P.; Somsen, G. W.; Domínguez-Vega, E. Heterogeneity Assessment of Antibody-Derived Therapeutics at the Intact and Middle-up Level by Low-Flow Sheathless Capillary Electrophoresis-Mass Spectrometry. Anal. Chim. Acta 2018, 1044, 181-190. DOI: https://doi.org/10.1016/j.aca.2018.08.024.
(2-22) Gstöttner, C.; Hook, M.; Christopeit, T.; Knaupp, A.; Schlothauer, T.; Reusch, D.; Haberger, M.; Wuhrer, M.; Domínguez-Vega, E. Affinity Capillary Electrophoresis-Mass Spectrometry as a Tool to Unravel Proteoform-Specific Antibody-Receptor Interactions. Anal. Chem. 2021, 93 (45), 15133-15141. DOI: 10.1021/acs.analchem.1c03560.
(2-23) Jooß, K.; Schachner, L. F.; Watson, R.; Gillespie, Z. B.; Howard, S. A.; Cheek, M. A.; Meiners, M. J.; Sobh, A.; Licht, J. D.; Keogh, M.-C.; et al. Separation and Characterization of Endogenous Nucleosomes by Native Capillary Zone Electrophoresis-Top-Down Mass Spectrometry. Anal. Chem. 2021, 93 (12), 5151-5160. DOI: 10.1021/acs.analchem.0c04975.
(2-24) Jarvas, G.; Szigeti, M.; Guttman, A. Effect of the Flow Profile on Separation Efficiency in Pressure-Assisted Reversed-Polarity Capillary Zone Electrophoresis of Anions: Simulation and Experimental Evaluation. J. Sep. Sci. 2018, 41 (11), 2473-2478. DOI: 10.1002/jssc.201701372.
(2-25) Mehaffey, M. R.; Xia, Q.; Brodbelt, J. S. Uniting Native Capillary Electrophoresis and Multistage Ultraviolet Photodissociation Mass Spectrometry for Online Separation and Characterization of Escherichia Coli Ribosomal Proteins and Protein Complexes. Anal. Chem. 2020, 92 (22), 15202-15211. DOI: 10.1021/acs.analchem.0c03784.
(2-26) Shen, X.; Kou, Q.; Guo, R.; Yang, Z.; Chen, D.; Liu, X.; Hong, H.; Sun, L. Native Proteomics in Discovery Mode Using Size-Exclusion Chromatography-Capillary Zone Electrophoresis-Tandem Mass Spectrometry. Anal. Chem. 2018, 90 (17), 10095-10099. DOI: 10.1021/acs.analchem.8b02725.
(2-27) Shen, X.; Liang, Z.; Xu, T.; Yang, Z.; Wang, Q.; Chen, D.; Pham, L.; Du, W.; Sun, L. Investigating Native Capillary Zone Electrophoresis-Mass Spectrometry on a High-End Quadrupole-Time-of-Flight Mass Spectrometer for the Characterization of Monoclonal Antibodies. Int. J. Mass Spectrom. 2021, 462, 116541. DOI: https://doi.org/10.1016/j.ijms.2021.116541.
(2-28) DeBastiani, A.; Majuta, S. N.; Sharif, D.; Attanayake, K.; Li, C.; Li, P.; Valentine, S. J. Characterizing Multidevice Capillary Vibrating Sharp-Edge Spray Ionization for in-Droplet Hydrogen/Deuterium Exchange to Enhance Compound Identification. ACS Omega 2021, 6 (28), 18370-18382. DOI: 10.1021/acsomega.1c02362.
(2-29) Jayasundara, K. U.; Li, C.; DeBastiani, A.; Sharif, D.; Li, P.; Valentine, S. J. Physicochemical Property Correlations with Ionization Efficiency in Capillary Vibrating Sharp-Edge Spray Ionization (Cvssi). J. Am. Soc. Mass Spectrom. 2021, 32 (1), 84-94. DOI: 10.1021/jasms.0c00100.
(2-30) Ranganathan, N.; Li, C.; Suder, T.; Karanji, A. K.; Li, X.; He, Z.; Valentine, S. J.; Li, P. Capillary Vibrating Sharp-Edge Spray Ionization (Cvssi) for Voltage-Free Liquid Chromatography-Mass Spectrometry. J. Am. Soc. Mass Spectrom. 2019, 30 (5), 824-831, journal article. DOI: 10.1007/s13361-019-02147-0.
(2-31) Li, C.; DeVor, A.; Wang, J.; Valentine, S. J.; Li, P. Rapid and Flexible Online Desalting Using Nafion-Coated Melamine Sponge for Mass Spectrometry Analysis. Rapid Commun. Mass Spectrom. 2022, 36 (17), e9341. DOI: https://doi.org/10.1002/rcm.9341.
(2-32) Pursell, M. E.; Sharif, D.; DeBastiani, A.; Li, C.; Majuta, S.; Li, P.; Valentine, S. J. Development of Cvssi-Apci for the Improvement of Ion Suppression and Matrix Effects in Complex Mixtures. Anal. Chem. 2022, 94 (26), 9226-9233. DOI: 10.1021/acs.analchem.1c05136.
(2-33) Li, C.; Attanayake, K.; Valentine, S. J.; Li, P. Facile Improvement of Negative Ion Mode Electrospray Ionization Using Capillary Vibrating Sharp-Edge Spray Ionization. Anal. Chem. 2020, 92 (3), 2492-2502. DOI: 10.1021/acs.analchem.9b03983.
(2-34) Sharif, D.; Foroushani, S. H.; Attanayake, K.; Dewasurendra, V. K.; DeBastiani, A.; DeVor, A.; Johnson, M. B.; Li, P.; Valentine, S. J. Capillary Vibrating Sharp-Edge Spray Ionization Augments Field-Free Ionization Techniques to Promote Conformer Preservation in the Gas-Phase for Intractable Biomolecular Ions. J. Phys. Chem. B 2022, 126 (44), 8970-8984. DOI: 10.1021/acs.jpcb.2c04960.
(2-35) Majuta, S. N.; DeBastiani, A.; Li, P.; Valentine, S. J. Combining Field-Enabled Capillary Vibrating Sharp-Edge Spray Ionization with Microflow Liquid Chromatography and Mass Spectrometry to Enhance ‘Omics Analyses. J. Am. Soc. Mass Spectrom. 2021, 32 (2), 473-485. DOI: 10.1021/jasms.0c00376.
(2-36) Kristoff, C. J.; Li, C.; Li, P.; Holland, L. A. Low Flow Voltage Free Interface for Capillary Electrophoresis and Mass Spectrometry Driven by Vibrating Sharp-Edge Spray Ionization. Anal. Chem. 2020, 92 (4), 3006-3013. DOI: https://doi.org/10.1021/acs.analchem.9b03994.
(2-37) Elshamy, Y. S.; Strein, T. G.; Holland, L. A.; Li, C.; DeBastiani, A.; Valentine, S. J.; Li, P.; Lucas, J. A.; Shaffer, T. A. Nanoflow Sheath Voltage-Free Interfacing of Capillary Electrophoresis and Mass Spectrometry for the Detection of Small Molecules. Anal. Chem. 2022, 94 (32), 11329-11336. DOI: 10.1021/acs.analchem.2c02074.
(2-38) White, C. M.; Luo, R.; Archer-Hartmann, S. A.; Holland, L. A. Electrophoretic Screening of Ligands under Suppressed Eof with an Inert Phospholipid Coating. Electrophoresis 2007, 28 (17), 3049-3055. DOI: 10.1002/elps.200600816.
(2-39) White, C. M.; Hanson, K. M.; Holland, L. A. Microseparations Distance CE: Capillary Electrophoresis Distance Learning Program: Guided Discovery on the Principles, Assembly, Operation and Application of a Custom Built Capillary Electrophoresis System. Analytical Sciences Digital Library: http://www.asdlib.org/2005, ASDL Entry 10031, available at https://collection.asdlib.org/micro-separations-distance-ce/.
(2-40) Marty, M. T.; Baldwin, A. J.; Marklund, E. G.; Hochberg, G. K. A.; Benesch, J. L. P.; Robinson, C. V. Bayesian Deconvolution of Mass and Ion Mobility Spectra: From Binary Interactions to Polydisperse Ensembles. Anal. Chem. 2015, 87 (8), 4370-4376. DOI: 10.1021/acs.analchem.5b00140.
(2-41) Sanz-Nebot, V.; Balaguer, E.; Benavente, F.; Neusüß, C.; Barbosa, J. Characterization of Transferrin Glycoforms in Human Serum by Ce-Uv and Ce-Esi-Ms. Electrophoresis 2007, 28 (12), 1949-1957. DOI: https://doi.org/10.1002/elps.200600648.
(2-42) Alomirah, H.; Alli, I.; Konishi, Y. Charge State Distribution and Hydrogen/Deuterium Exchange of A-Lactalbumin and B-Lactoglobulin Preparations by Electrospray Ionization Mass Spectrometry. J. Agric. Food Chem. 2003, 51 (7), 2049-2057. DOI: 10.1021/jf020816e.
(2-43) Olguin-Arredondo, H.; Vallejo-Córdoba, B. Separation and Determination of Beta-Lactoglobulin Variants a and B in Cow's Milk by Capillary Free Zone Electrophoresis. J Capill Electrophor Microchip Technol 1999, 6 (5-6), 145-149.
(2-44) Bell, K.; McKenzie, H. A.; Shaw, D. C. Amino Acid Composition and Peptide Maps of B-Lactoglobulin Variants. Biochimica et Biophysica Acta (BBA)—Protein Structure 1968, 154 (2), 284-294. DOI: https://doi.org/10.1016/0005-2795(68)90042-1.
(2-45) Quaranta, A.; Spasova, M.; Passarini, E.; Karlsson, I.; Ndreu, L.; Thorsén, G.; Ilag, L. L. N-Glycosylation Profiling of Intact Target Proteins by High-Resolution Mass Spectrometry (Ms) and Glycan Analysis Using Ion Mobility-Ms/Ms. Analyst 2020, 145 (5), 1737-1748, 10.1039/C9AN02081K. DOI: 10.1039/C9AN02081K.
(2-46) Haselberg, R.; Ratnayake, C. K.; de Jong, G. J.; Somsen, G. W. Performance of a Sheathless Porous Tip Sprayer for Capillary Electrophoresis-Electrospray Ionization-Mass Spectrometry of Intact Proteins. J. Chromatogr. A 2010, 1217 (48), 7605-7611. DOI: https://doi.org/10.1016/j.chroma.2010.10.006.
(2-47) Haselberg, R.; de Jong, G. J.; Somsen, G. W. Capillary Electrophoresis-Mass Spectrometry of Intact Basic Proteins Using Polybrene-Dextran Sulfate-Polybrene-Coated Capillaries: System Optimization and Performance. Anal. Chim. Acta 2010, 678 (1), 128-134. DOI: https://doi.org/10.1016/j.aca.2010.08.032.
(2-48) Krenkova, J.; Klepamik, K.; Luksch, J.; Foret, F. Microfabricated Liquid Junction Hybrid Capillary Electrophoresis-Mass Spectrometry Interface for Fully Automated Operation. Electrophoresis 2019, 40 (18-19), 2263-2270. DOI: https://doi.org/10.1002/elps.201900049.
(2-49) Hamidli, N.; Andrasi, M.; Nagy, C.; Gaspar, A. Analysis of Intact Proteins with Capillary Zone Electrophoresis Coupled to Mass Spectrometry Using Uncoated and Coated Capillaries. J. Chromatogr. A 2021, 1654, 462448. DOI: https://doi.org/10.1016/j.chroma.2021.462448.
(2-50) Enke, C. G. A Predictive Model for Matrix and Analyte Effects in Electrospray Ionization of Singly-Charged Ionic Analytes. Anal. Chem. 1997, 69 (23), 4885-4893. DOI: 10.1021/ac970095w.
(2-51) Clarke, D. J.; Campopiano, D. J. Desalting Large Protein Complexes During Native Electrospray Mass Spectrometry by Addition of Amino Acids to the Working Solution. Analyst 2015, 140 (8), 2679-2686, 10.1039/C4AN02334J. DOI: 10.1039/C4AN02334J.
(2-52) Pan, P.; Gunawardena, H. P.; Xia, Y.; McLuckey, S. A. Nanoelectrospray Ionization of Protein Mixtures: Solution Ph and Protein Pi. Anal. Chem. 2004, 76 (4), 1165-1174. DOI: 10.1021/ac035209k.
(2-53) Konermann, L.; Douglas, D. J. Unfolding of Proteins Monitored by Electrospray Ionization Mass Spectrometry: A Comparison of Positive and Negative Ion Modes. J. Am. Soc. Mass Spectrom. 1998, 9 (12), 1248-1254. DOI: 10.1016/S1044-0305(98)00103-2.
(2-54) Cao, P.; Moini, M. Analysis of Peptides, Proteins, Protein Digests, and Whole Human Blood by Capillary Electrophoresis/Electrospray Ionization-Mass Spectrometry Using an in-Capillary Electrode Sheathless Interface. J. Am. Soc. Mass Spectrom. 1998, 9 (10), 1081-1088. DOI: 10.1016/S1044-0305(98)00081-6.
(2-55) Puerta, A.; Axén, J.; Söderberg, L.; Bergquist, J. Novel Adsorptive Polyamine Coating for Enhanced Capillary Electrophoresis of Basic Proteins and Peptides. J. Chromatogr. B 2006, 838 (2), 113-121. DOI: https://doi.org/10.1016/j.jchromb.2006.04.018.
(2-56) Belov, A. M.; Viner, R.; Santos, M. R.; Horn, D. M.; Bern, M.; Karger, B. L.; Ivanov, A. R. Analysis of Proteins, Protein Complexes, and Organellar Proteomes Using Sheathless Capillary Zone Electrophoresis—Native Mass Spectrometry. J. Am. Soc. Mass Spectrom. 2017, 28 (12), 2614-2634. DOI: 10.1007/s13361-017-1781-1.
(2-57) Hajba, L.; Guttman, A. Recent Advances in Column Coatings for Capillary Electrophoresis of Proteins. TrAC, Trends Anal. Chem. 2017, 90, 38-44. DOI: https://doi.org/10.1016/j.trac.2017.02.013.
(2-58) Huhn, C.; Ramautar, R.; Wuhrer, M.; Somsen, G. W. Relevance and Use of Capillary Coatings in Capillary Electrophoresis-Mass Spectrometry. Anal. Bioanal. Chem. 2010, 396 (1), 297-314.
(2-59) Lucy, C. A.; MacDonald, A. M.; Gulcev, M. D. Non-Covalent Capillary Coatings for Protein Separations in Capillary Electrophoresis. J. Chromatogr. A 2008, 1184 (1), 81-105. DOI: https://doi.org/10.1016/j.chroma.2007.10.114.
(2-60) Cunliffe, J. M.; Baryla, N. E.; Lucy, C. A. Phospholipid Bilayer Coatings for the Separation of Proteins in Capillary Electrophoresis. Anal. Chem. 2002, 74, 776-783.
(2-61) Wells, S. S.; De La Toba, E.; Harrison, C. R. Metal Cation Control of Electroosmotic Flow Magnitude in Phospholipid-Coated Capillaries. Electrophoresis 2016, 37 (10), 1303-1309. DOI: 10.1002/elps.201600012.
(2-62) Crihfield, C. L.; Kristoff, C. J.; Veltri, L. M.; Penny, W. M.; Holland, L. A. Semi-Permanent Cationic Coating for Protein Separations. J. Chromatogr. A 2019, 1607 (6), 460397.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. An apparatus, comprising:
a separation capillary having an injection end and a distal end, the injection end configured to receive analyte liquid and the distal end configured to expel the analyte liquid;
a sheath capillary covering the distal end of the separation capillary, the sheath capillary having a diameter that is greater than an outer diameter of the separation capillary at the distal end, the sheath capillary having a first end and a second end, the distal end of the separation capillary positioned between the first end and the second end of the sheath capillary, the sheath capillary carrying a fluid between the second end and the first end;
an acoustic probe configured to vibrate positioned in contact with the at least one of the distal end of the separation capillary or the first end of the sheath capillary; and
a ground terminal positioned at the first end of the sheath capillary.

2. The apparatus of claim 1, wherein a flow rate of the fluid in the sheath capillary is less than one microliter per minute.

3. The apparatus of claim 1, wherein a longitudinal axis of the acoustic probe is positioned between 80 degrees to 125 degrees in relation to a longitudinal axis of at least one of the separation capillary or the first end of the sheath capillary.

4. The apparatus of claim 1, wherein the separation capillary has a length, measured between the injection end and the distal end, between 5 cm and 2 m.

5. The apparatus of claim 1, wherein the separation capillary has a total volume of no more than 8 micro-liters.

6. The apparatus of claim 1, wherein an inner diameter of the separation capillary is between 15 micrometers and 35 micrometers.

7. The apparatus of claim 1, wherein a distance between the distal end of the separation capillary and the ground terminal is less than 2 millimeters.

8. The apparatus of claim 1, wherein a voltage difference is maintained between the injection end of the separation capillary and the ground terminal.

9. The apparatus of claim 1, wherein a flow rate of the analyte liquid in the separation capillary is between 0 nano-liters and 70 nano-liters.

10. The apparatus of claim 1, wherein at least a portion of the inner surface of the separation capillary is coated with lipids.

11. The apparatus of claim 10, wherein electroosmotic flow within the separation capillary is suppressed.

12. The apparatus of claim 1, wherein the analyte liquid includes small or large molecules that are positively charged, negatively charged, or neutral charged.

13. The apparatus of claim 1, wherein the analyte liquid includes cationic proteins and acidic background electrolytes.

14. The apparatus of claim 1, wherein the analyte liquid includes cationic proteins, and wherein at least a portion of the inner surface of the separation capillary has at least one of a net neutral lipid coating or a hybrid cationic lipid coating.

15. The apparatus of claim 14, wherein the at least one of a net neutral lipid coating or a hybrid cationic lipid coating is semi-permanent.

16. The apparatus of claim 14, wherein the at least one of a net neutral lipid coating or a hybrid cationic lipid coating is positively charged.

17. The apparatus of claim 1, wherein the analyte liquid includes anionic or neutral proteins and an electrolyte buffer at a pH of above 7.

18. The apparatus of claim 1, wherein the fluid in the sheath capillary is an electrolyte with neutral pH.

19. The apparatus of claim 18, wherein the fluid in the sheath capillary includes one or more amino acid additives.

20. The apparatus of claim 19, wherein the one or more amino acid additives include at least one of L-serine, D-serine, or amino acid additives or L- or D-configuration.

21. An apparatus, comprising:
a separation capillary having an injection end and a distal end, the injection end configured to receive analyte liquid and the distal end configured to expel the analyte liquid;
an acoustic probe capillary having a probe end and an inlet end, the probe end of the acoustic probe capillary configured to vibrate and positioned in contact with the distal end of the separation capillary, the acoustic probe capillary carrying a fluid from the inlet end to the probe end; and
a ground terminal positioned at the distal end of the separation capillary.

22. The apparatus of claim 21, further comprising:
a connector having a conduit for removably receiving the separation capillary, the connector including a slot to accommodate the acoustic probe capillary, wherein the conduit and the slot are positioned such that the probe end of the acoustic probe capillary makes contact with the distal end of the separation capillary.

23. The apparatus of claim 22, wherein the connector further includes a housing to house a ground terminal, wherein the housing and the conduit are positioned to such that the ground terminal makes contact with the distal end of the separation capillary.

24. The apparatus of claim 22, wherein a portion of the acoustic probe capillary is coupled with a vibrating structure.

25. The apparatus of claim 24, wherein the vibrating structure includes a piezoelectric transducer.

26. The apparatus of claim 21, wherein a flow rate of the fluid in the acoustic probe capillary is less than one microliter per minute.

27. The apparatus of claim 21, wherein the separation capillary has a length, measured between the injection end and the distal end, between 5 cm and 2 m.

28. The apparatus of claim 21, wherein the separation capillary has a total volume of no more than 8 micro-liters.

29. The apparatus of claim 21, wherein a voltage difference is maintained between the injection end of the separation capillary and the ground terminal.

30. The apparatus of claim 21, wherein an inner diameter of the separation capillary is between 15 micrometers to 35 micrometers.

31. The apparatus of claim 21, wherein a distance between the distal end of the separation capillary and the ground terminal is less than 2 millimeters.

32. The apparatus of claim 21, wherein a flow rate of the analyte liquid in the separation capillary is between 0 nano-liters and 70 nano-liters.

33. The apparatus of claim 21, wherein at least a portion of the inner surface of the separation capillary is coated with lipids.

34. The apparatus of claim 21, wherein electroosmotic flow within the separation capillary is suppressed.

35. The apparatus of claim 21, wherein the analyte liquid includes small or large molecules that are positively charged, negatively charged, or neutral charged.

36. The apparatus of claim 21, wherein the analyte liquid includes cationic proteins and acidic background electrolytes.

37. The apparatus of claim 21, wherein the analyte liquid includes cationic proteins, and wherein at least a portion of the inner surface of the separation capillary has at least one of a net neutral lipid coating or a hybrid cationic lipid coating.

38. The apparatus of claim 37, wherein the at least one of a net neutral lipid coating or a hybrid cationic lipid coating is semi-permanent.

39. The apparatus of claim 37, wherein the at least one of a net neutral lipid coating or a hybrid cationic lipid coating is positively charged.

40. The apparatus of claim 21, wherein the analyte liquid includes anionic or neutral proteins and an electrolyte buffer at a pH of above 7.

41. The apparatus of claim 21, wherein the fluid in the acoustic probe capillary is an electrolyte with neutral pH.

42. The apparatus of claim 41, wherein the fluid in the acoustic probe capillary includes one or more amino acid additives.

43. The apparatus of claim 42, wherein the one or more amino acid additives include at least one of L-serine, D-serine, or amino acid additives or L- or D-configuration.

44. A connector, comprising:
a connector body having a first end and a second end;
a conduit extending between the first end and the second end of the connector body, the conduit configured to removably receive a separation capillary, wherein a portion of the conduit at the first end of the connector body accommodates a distal end of the separation capillary; and
an acoustic probe slot positioned at the first end of the connector body, the acoustic probe slot extends between an outside surface of the connector body and the inner surface of the conduit, the acoustic probe slot configured to removably receive an acoustic probe having a sheath capillary.

45. The connector of claim 44, further comprising:
a ground terminal slot positioned at the first end of the connector body, the ground terminal slot extends between an outside surface of the connector body and an inner surface of the conduit, ground terminal slot configured to removably receive a ground terminal.

46. The connector of claim 44, further comprising:
A dead stop positioned in the conduit at the first end of the connector body, the dead stop configured to have a diameter that is less than a diameter of the separation capillary such that the separation capillary is prevented from being pushed out of the conduit at the first end.

47. The connector of claim 44, wherein the connector body is formed of at least one of metal or thermoplastic.

48. The connector of claim 44, wherein the connector body includes a dead stop formed on an inner surface of the conduit, wherein the dead stop has a diameter that is less than the diameter of the separation capillary.

49. The connector of claim 44, wherein the connector body comprises:
a nut portion and a port portion, wherein the nut portion screws into the port portion, wherein a portion of the conduit is formed in the nut portion and a second portion of the conduit is formed in the port portion, and
a dead stop formed on the inner surface of the second portion of the conduit in the port portion, wherein the dead stop has a diameter that is less than the diameter of the separation capillary.

50. The connector of claim 49, further comprising;
a ground terminal slot positioned at the first end of the connector body, the ground terminal slot extends between an outside surface of the connector body and an inner surface of the conduit, ground terminal slot configured to removably receive a ground terminal, wherein the ground terminal slot is formed in the port portion.

51. The connector of claim 49, wherein the acoustic probe slot is formed in the port portion.
